(19) United States
(12) Patent Application Publication
(10) Pub. No.: US 2012/0030329 A1
(43) Pub. Date: Feb. 2, 2012

(54) Information processing apparatus, linked scenario preparation method for information processing apparatus, program, and storage medium

(75) Inventors: Satoshi Aoki, Kanagawa (JP); Hiroki Ohzaki, Kanagawa (JP)

(73) Assignee: Ricoh Company, Ltd., Tokyo (JP)

(21) Appl. No.: 13/067,906

(22) Filed: Jul. 6, 2011

(30) Foreign Application Priority Data
Jul. 30, 2010 (JP) 2010-172996

(51) Int. Cl. G06F 15/173

(52) U.S. Cl. 709/223

(57) ABSTRACT

An information processing apparatus connectable to other information processing apparatuses useable as link partner apparatuses via a network can prepare a linked scenario. The linked scenario is preparable by linking a plurality of discrete services providable by the information processing apparatus and the link partner apparatuses. The information processing apparatus includes a processor to conduct the steps of: storing link information arranging each of the discrete services providable by the information processing apparatus and the link partner apparatuses from high to low linking closeness trend; preparing a plurality of path patterns for the linked scenario by linking a plurality of discrete services based on the link information, in which the path patterns are prepared to satisfy an inputting format and an outputting format designated for the linked scenario; displaying the plurality of path patterns prepared for the linked scenario; and registering a primary linked scenario by selecting one path.

### CROSS-REFERENCE TO RELATED APPLICATIONS

This application claims priority to Japanese Patent Application No. 2010-172996, filed on Jul. 30, 2010 in the Japan Patent Office, which is incorporated by reference herein in its entirety.

### BACKGROUND OF THE INVENTION

1. Field of the Invention

The present invention relates to an information processing apparatus such as an image forming apparatus available as a printer, a facsimile machine, a copier, or a multi-functional apparatus, also known as multi-functional peripherals (MFP), a linked scenario preparation method for the information processing apparatus, a program executable by a computer to control the information processing apparatus, and a computer-readable storage medium storing the program.

2. Description of the Background Art

Information processing apparatuses or devices distributed on a network as a distributed network system can provide a single integrated service by linking discrete services disposed at each of several different apparatuses or devices, which is prepared as a linked scenario. For example, JP-2008-21095-A discloses a linked scenario preparation support system for preparing a linked scenario by general users, who may not be familiar with network protocols or rules and/or knowledgeable about computers, by sequentially selecting discrete services one by one and linking the selected services selectively.

However, even in such linked scenario preparation support system, a user may need to select a plurality of discrete services one by one sequentially and link the selected discrete services, which means the user needs to link individual services manually to prepare a given combination of discrete services even if the combination may be a predictable one. Such preparatory work can be too complex for general users.

### SUMMARY

In one aspect of the present invention, an information processing apparatus connectable to other information processing apparatuses useable as link partner apparatuses via a network for preparing a linked scenario is devised. The linked scenario is preparable by selecting and linking a plurality of discrete services providable by the information processing apparatus and the link partner apparatuses. The linked scenario is composed of selected and linked discrete services operable by a given combination of the information processing apparatus and the link partner apparatuses The information processing apparatus includes a processor configured to conduct the steps of: storing link information arranging each of the discrete services providable by the information processing apparatus and the link partner apparatuses as link candidates, successively arranged from high to low linking closeness trend set for the discrete services; preparing a plurality of path patterns for the linked scenario by linking a plurality of discrete services based on the link information, in which the path patterns are prepared to satisfy an inputting format and an outputting format designated for the linked scenario; displaying the plurality of path patterns prepared for the linked scenario as a path list; and registering a primary linked scenario by selecting one path from the path list.

In another aspect of the present invention, a method of preparing a linked scenario using an information processing apparatus connectable to other information processing apparatuses useable as link partner apparatuses via a network is devised. The linked scenario is preparable by selecting and linking a plurality of discrete services providable by the information processing apparatus and the link partner apparatuses. The linked scenario is composed of selected and linked discrete services operable by a given combination of the information processing apparatus and the link partner apparatuses The information processing apparatus includes a processor configured to conduct the steps of: storing link information arranging each of the discrete services providable by the information processing apparatus and the link partner apparatuses as link candidates, successively arranged from high to low linking closeness trend set for the discrete services; preparing a plurality of path patterns for the linked ‘scenario by linking a plurality of discrete services based on the link information, in which the path patterns are prepared to satisfy an inputting format and an outputting format designated for the linked scenario; displaying the plurality of path patterns prepared for the linked scenario as a path list; and registering a primary linked scenario by selecting one path from the path list.

In another aspect of the present invention, a computer-readable medium storing a program comprising instructions that when executed by a computer cause the computer to execute a method of preparing a linked scenario using an information processing apparatus connectable to other information processing apparatuses useable as link partner apparatuses via a network is devised. The linked scenario is preparable by selecting and linking a plurality of discrete services providable by the information processing apparatus and the link partner apparatuses. The linked scenario is composed of selected and linked discrete services operable by a given combination of the information processing apparatus and the link partner apparatuses The information processing apparatus includes a processor configured to conduct the steps of: storing link information arranging each of the discrete services providable by the information processing apparatus and the link partner apparatuses as link candidates, successively arranged from high to low linking closeness trend set for the discrete services; preparing a plurality of path patterns for the linked scenario by linking a plurality of discrete services based on the link information, in which the path patterns are prepared to satisfy an inputting format and an outputting format designated for the linked scenario; displaying the plurality of path patterns prepared for the linked scenario as a path list; and registering a primary linked scenario by selecting one path from the path list.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows a block diagram of a network system according to an example embodiment;

FIG. 2 shows a hardware configuration of each image forming apparatus of FIG. 1;

FIG. 3 shows software-implementing functions of each image forming apparatus of FIG. 1;

FIG. 4 shows a functional block diagram of a main processing section of each image forming apparatus of FIG. 1;

FIG. 5 shows an example of a log-in screen displayed on an operation display unit of each of the image forming apparatus of FIG. 4;

FIG. 6 shows an example of a menu of application selection displayed on an operation display unit of each of the image forming apparatus of FIG. 4;

FIG. 7 shows an example of a linked scenario preparation screen displayed on an operation display unit of each of the image forming apparatus of FIG. 4;

FIG. 8 shows an example of a linked scenario list displayed on an operation display unit of each of the image forming apparatus of FIG. 4;

FIG. 9 shows an example of a message displayed on an operation display unit of each of the image forming apparatus of FIG. 4 when registering a linked scenario;

FIG. 10 shows an example of data types and formats stored in a discrete service DB of FIG. 4;

FIG. 11 shows one example of data types and formats stored in a linked scenario DB of FIG. 4;

FIGS. 12A and 12B show example of data types and formats stored in a linked scenario statistics DB of FIG. 4;

FIG. 13 shows one example of data types and formats stored in a link partner DB of FIG. 4;

FIG. 14 shows an example sequence chart of exchanging resource information among image forming apparatuses of FIG. 1;

FIG. 15 shows a flowchart of processes carried out when the image forming apparatuses of FIG. 4 is used;

FIG. 16 shows a plurality of discrete services useable for configuring a linked scenario when an inputting-format of “paper” and an outputting-format of “PDF” are designated for the image forming apparatuses of FIG. 4, and a data referring process to the discrete service DB for determining a linking sequence of discrete services;

FIG. 17 shows a plurality of discrete services useable for configuring a linked scenario when an inputting-format of “paper” and an outputting-format of “PDF” are designated for image forming apparatuses of FIG. 4, and an algorithm for determining a linking sequence of discrete services;

FIG. 18 shows the data referring process continued from FIG. 16;

FIG. 19 shows the algorithm continued from FIG. 17;

FIG. 20 shows the algorithm continued from FIG. 19;

FIG. 21 shows a data referring process to priority order information of each of priority items in a linked scenario statistics DB when selecting an image forming apparatus from a plurality of image forming apparatuses of FIG. 4 that can provide a discrete service of PDF conversion; and

FIG. 22 shows an algorithm to select an image forming apparatus from a plurality of image forming apparatuses of FIG. 4 that can provide a discrete service of PDF conversion.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner.

Referring now to the drawings, a system, which can be used with a network, according to example embodiment is described hereinafter.

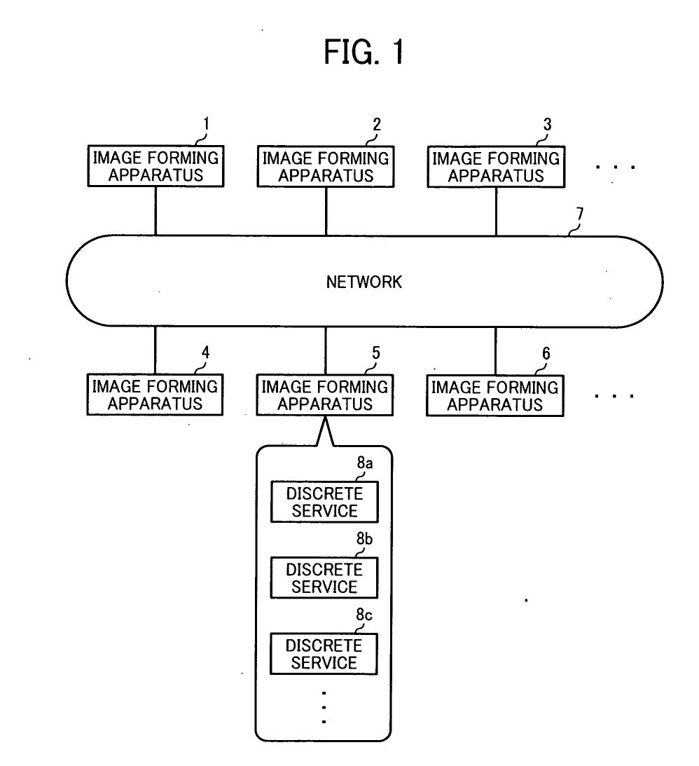

A description is now given of a network system according to an example embodiment with reference to FIG. 1, which shows one example configuration of the network system. In the network system, a plurality of image forming apparatuses 1 to 6 are connectable to each other via a network 7 and can communicate information each other via the network 7. FIG. 1 shows the image forming apparatuses 1 to 6, but other image forming apparatuses or other information processing apparatus such as a server, a personal computer (PC), or the like can be connected to the network system. Each of the image forming apparatuses 1 to 6 may be an image processing apparatus such as a facsimile machine, a printer, a copier, a multi-functional apparatus, which may be known as multi-functional peripherals (MFP), or the like, but not limited thereto. The network 7 may be a wired network or a wireless network, and the network 7 may be a public communication network such as the internet or private communication network.

Each of the image forming apparatuses 1 to 6, connectable to each other or one to another via the network 7, can provide a plurality of discrete services possessed or included in each of the image forming apparatuses 1 to 6 to other image forming apparatuses, which means one image forming apparatus can conduct a given job by utilizing a plurality of discrete services provided from other image forming apparatuses in an interactive manner.

For example, as shown in FIG. 1, the image forming apparatus 5 may have a group of discrete services such as a plurality of discrete services 8a, 8b, 8c, which can be used by the image forming apparatus 5 itself and can be provided to other image forming apparatuses 1, 2, 3, 4, and 6. Likewise, each of the image forming apparatuses 1, 2, 3, 4, and 6 may have a group of discrete services which can be used by itself and can be provided to other image forming apparatuses. The term “discrete service” means an entity to handle a to-be-processed object such a job in a computing environment, and includes processes and/or data that can be used on the network 7. Such image forming apparatuses 1, 2, 3, 4, 5, and 6 can be referred to as link partner apparatuses collectively, in which when a user operates the image forming apparatus 1 to conduct a given job, other image forming apparatuses 2, 3, 4, 5, and 6 can be used as the link partner apparatuses for the image forming apparatus 1.

For example, the image forming apparatuses 1 to 6 has a communication function to communicate with other image forming apparatuses via a communication line, a facsimile communication function (FAX communication) to transmit and receive facsimile, an image scanning function (scanning function) to optically scan text and/or image on document sheet such as paper and to input image data, a portable document format (PDF) conversion function to convert document data to a file format of document such as portable document format (PDF), an optical character reading (OCR) function to recognize characters in data, or the like. It should be noted that the following example embodiment for processing information or data can be applied to various types of information processing apparatuses, not limited to image forming apparatuses such as printers, copiers, etc.

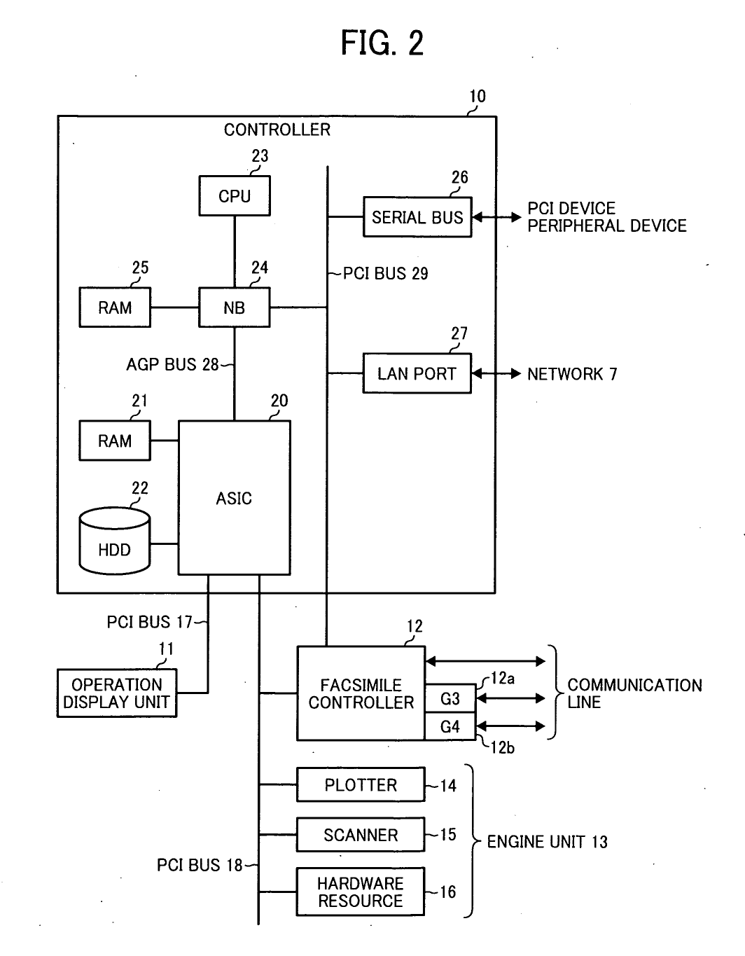

Each of the image forming apparatuses 1 to 6 may have a hardware configuration shown in FIG. 2. FIG. 2 shows an example hardware configuration of the image forming apparatuses 1 to 6 of FIG. 1. Each of the image forming apparatuses 1 to 6 included a controller 10, an operation display unit 11 (such as an operation panel), a facsimile controller 12, and an engine unit 13.

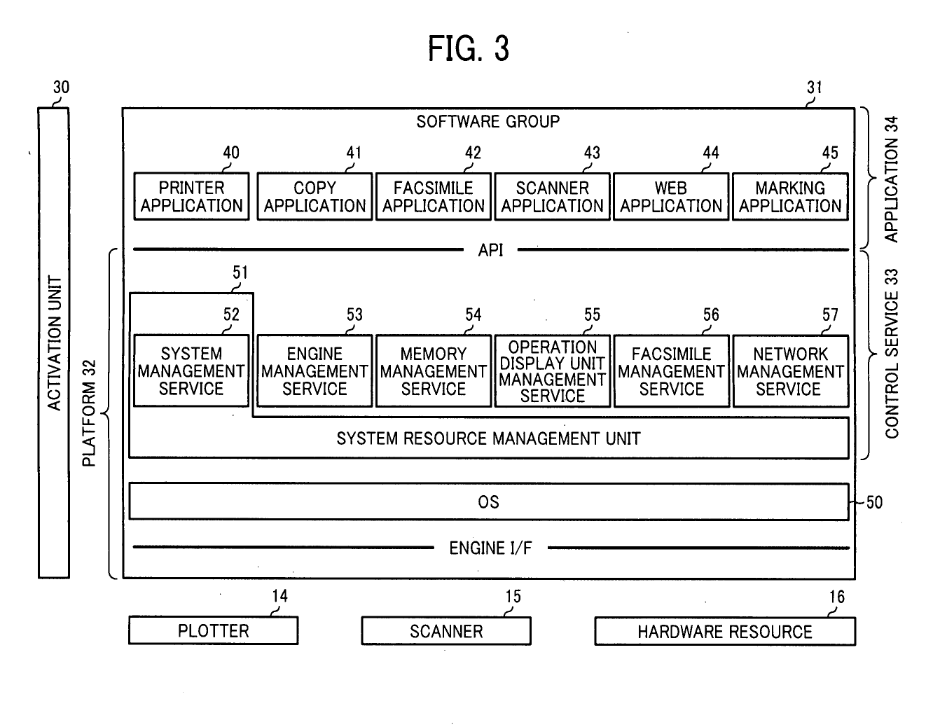

In the controller 10, an application specific integrated circuit (ASIC) 20 is connected to a random access memory (RAM) 21, and a hard disk drive (HDD) 22. The ASIC 20 is connected to a central processing unit (CPU) 23 and a RAM 25 via a NB 24 in the CPU chip set, and the ASIC 20 and the NB 24 may be connectable to each other via an accelerated graphics port (AGP) bus 28 instead of a peripheral component interconnect (PCI) bus. The AGP bus may be used as a bus to connect units each other because the data transmission speed of AGP bus can be set faster than the PCI bus. Each of the image forming apparatuses 1 to 6 may be used to control and execute a plurality of processes using a platform 32 and an application 34 such as application programs to be described later with FIG. 3, in which processing performance at the image forming apparatuses may deteriorate if a low speed bus such as PCI bus is used for data transmission. The controller 10 can be configured using various types of processors, circuits, or the like such as a programmed processor, a circuit, an application specific integrated circuit (ASIC), used singly or in combination.

In each of the image forming apparatuses 1 to 6, the CPU 23 may control each unit in the image forming apparatus to control the image forming apparatus as a whole. Specifically, the CPU 23 activates and executes services included in the platform 32 on an operating system (OS) 50 shown in FIG. 3, wherein the platform 32 may include services such as a system resource management unit 51, a system management service 52, an engine management service 53, a memory management service 54, an operation display unit management service 55, a facsimile management service 56, and a network management service 57, and each of such services can be activated and executed by the CPU 23.

The CPU 23 can further activate and execute an application 34, wherein the application 34 may include a printer application program (printer application 40), a copy application program (copy application 41), a facsimile application program (facsimile application 42), a scanner application program (scanner application 43), a web application program (web application 44), and a marking application program (marking application 45).

The NB24 may be used as a bridge for connecting the CPU 23, the RAM 25, a serial bus 26, the ASIC 20, and a local area network (LAN) port 27. The RAM 25 may be a system memory used as a working memory, including an image drawing memory, in each of the image forming apparatuses 1 to 6. The serial bus 26 is connected to the NB24 via a PCI bus 29, and connected to the ASIC 20, the CPU 23, PCI devices, and peripheral devices via the NB24. The RAM 21 is a local memory used such as a buffer for copying image data, a buffer for code data, or the like. The ASIC 20 is an integrated circuit (IC) having hardware resources for forming and/or processing image.

The LAN port 27 is connected to the NB 24 via the PCI bus 29, and further connected to the ASIC 20 and the CPU 23 via the NB 24. The LAN port 27 can be connected to the network 7 to connect the image forming apparatuses and/or image processing apparatuses (e.g., server, PC) each other via the network 7. The LAN port 27 may be connected to the network 7 using a LAN cable or connected to the network 7 using a wireless system. As such, the LAN port 27 may be used as an interface (I/F) for the image forming apparatuses 1 to 6.

The HDD 22 is a storage device to store image data, programs such as a program prepared for the present invention, font data, and form data, or the like.

In such configuration, the ASIC 20 may include a RAM interface connectable to the RAM 21, and a hard disk interface connectable to the HDD 22, and when the ASIC 20 conducts an input/output of image data with such storages, the input/output of image data is directed any one of the RAM interface and hard disk interface with a switching manner. The AGP bus 28 is a bus interface for graphics accelerator card for enhancing a graphic processing speed, by which the graphics accelerator card can directly access a system memory with a high throughput, which means the graphics accelerator card can access the system memory with a high speed.

Further, the ASIC 20 may be connected to the operation display unit 11 via a PCI bus 17, and may be connected to the facsimile controller 12 and the engine unit 13 via a PCI bus 18. The operation display unit 11 may be an operation panel, which receives an input operation from an operator and displays information for an operator. The facsimile controller 12 may include a G3 facsimile controller 12a and a G4 facsimile controller 12b, by which the G3 or G4 facsimile transmission/reception via a communication line (e.g., public communication line) between one image forming apparatus and other image forming apparatus is controlled.

The engine unit 13 may include a plotter 14, a scanner 15, and hardware resource 16, in which the plotter 14 is a printing unit, the scanner 15 is an image scanning unit, and the hardware resource 16 may be used for other functional units. The engine unit 13 controls the image. data printing by the plotter 14, the image scanning by the scanner 15, and other functions conducted using the hardware resource 16.

A description is given of software-implementing functional units of the image forming apparatuses 1 to 6 with reference to FIG. 3. FIG. 3 shows an example block diagram of software-implementing functional units of the image forming apparatuses 1 to 6 shown in FIG. 1. Further, FIG. 3 shows a portion of hardware configuration of functional units of the image forming apparatuses 1 to 6.

Each of the image forming apparatuses 1 to 6 includes a hardware configuration including the plotter 14, the scanner 15, ‘the hardware resource 16 such as facsimile communication or the like, and includes a software configuration including an activation unit 30 and a software group 31. The software group 31 may include a platform 32, and the platform 32 may include a control service 33, and the software group 31 may further include an application 34. When each of the image forming apparatuses 1 to 6 is supplied with power, the activation unit 30 is activated at first, and the activation unit 30 activates the platform 32. Further, when an operation of each application is requested, the activation unit 30 activates a requested application in the application 34.

The platform 32 includes the control service 33 to interpret a processing request requested by each application in the application 34, and to generate an obtaining request for hardware resources. Further, the platform 32 may include the function of the system resource management unit 51 and the OS 50 to manage a plurality of hardware resources by managing the obtaining request from the control service 33. The control service 33 may include a plurality of service modules. Specifically, the control service 33 includes the system management service 52, the engine management service 53, the memory management service 54, the operation display unit management service 55, the facsimile management service 56, and the network management service 57. Further, the platform 32 may include an application program interface (API) to receive a processing request from each of the above applications using functions defined in advance.

The OS 50, which may be an operating system such as UNIX (registered trademark), executes the platform 32 and each software program in the application 34 in a parallel manner. If the OS 50 uses an open-source software such as UNIX, program security can be secured while remaining adaptable to a network, and source codes can be obtained easily. Further, royalty fees for OS and transmission control protocol/internet protocol (TCP/IP) can be eliminated, and the outsourcing can become easy.

The system resource management unit 51 conducts the system control and resource management with the system management service 52. When a request is issued by an upper layer, the system resource management unit 51 controls the engine unit 13 (e.g., plotter 14, scanner 15, hardware resource 16), and manages hardware resources such as a memory, a HDD file, a network I/F in view of the resource request from the upper layer to execute given processes.

Specifically, the system resource management unit 51 determines whether a hardware resource requested by one requested is available for use. In other words, the system resource management unit 51 determines whether the requested hardware resource is being currently used by another request. If the system resource management unit 51 determines that the requested hardware resource is available for use, the system resource management unit 51 reports to the upper layer that the requested hardware resource is available for use. Further, based on a request from the upper layer, the system resource management unit 51 determines an availability scheduling of hardware resources, by which the requested contents (e.g., sheet transportation and image forming operation by the plotter 14, securing of memory area, generation of file) can be conducted directly.

The system management service 52 conducts a plurality of functions such as an application management (function 1), an operation display unit control (function 2), a system screen display such as a job list screen, a counter display screen (function 3), an LED display (function 4), a resource management (function 5), and an application interruption control (function 6), or the like.

Specifically, the application management (function 1) is used to register an application and to report the registration information to other applications.

The operation display unit control (function 2) is used to control a use of operation display unit by each application by determining which application has a use priority of operation display unit (exclusive use of operation display unit).

The system screen display (function 3) is used to display a warning screen corresponding to a state of the engine unit 13 in response to the request from the application having the use priority of operation display unit.

The LED display (function 4) is used to control a display of system LED such as a warning LED, an application key, or the like.

The resource management (function 5) is used to manage resources in a given manner such as exclusive control of engine resources (e.g., scanner, staple) that need to be excluded when one application is to conduct a job.

The application interruption control (function 6) is used to control an activation of application, in which a specific application is executed with a higher priority compared to other applications (i.e., control of application priority).

The engine management service 53 controls the engine unit 13 to control the plotter 14, the scanner 15, and the hardware resource 16, in which the image reading or scanning operation, image printing operation, condition reporting, jam recovering, or the like may be conducted.

The memory management service 54 conducts a memory management or control. Specifically, the memory management service 54 obtains and releases an image memory, conducts use of HDD, and conducts compression and extension of image data.

The operation display unit management service 55 is a module to control the operation display unit (operation panel) used as an information communication unit between an operator (or user) and a main controller. The operation display unit management service 55 reports a key operation event by an operator to the main control unit; provides library function used for configuring a graphical user interface (GUI) by each application; manages the configured GUI information for each application; and displays information such as input information, processed information or the like on an operation panel.

The facsimile management service 56 conducts the facsimile transmission/reception by each application of a system controller using a communication network such as, for example, public switched telephone networks (PSTN), integrated services digital network (ISDN) or the like; conducts registration and retrieval of facsimile data managed by a backup SRAM (BKM); and provides an application program interface (API) for conducting facsimile reading, printing of received facsimile, and combined transmission and reception of facsimile.

The network management service 57 is a module to provide a service that can be used by any applications, which require a network input/output (I/O). Specifically, the network management service 57 allocates or distributes data received from the network with given protocols to each of applications, and transmits data from each of applications to the network. As such, the network management service 57 functions as an information intermediary. In an example embodiment, the network management service 57 may use hypertext transfer protocol daemon (HTTPd), which may be selected from a plurality of protocols used for data communication. Specifically, the network management service 57 controls data communication with a network device connected via the Internet using HTTP (hypertext transfer protocol) by hypertext transfer protocol daemon (HTTPd), in which a web service designated by a HTTP request header is activated by a function call, and then the result processed by the web service is reported to the network device as HTTP response. For example, a message written by extensible markup language (XML) is used for processing data.

The application 34 may include a plurality of applications as follows. For example, the printer application 40 includes a printer application 40 including page description language (PDL), program check list (PCL), and post script (PS) as an application program for printer, the copy application 41 as a copy application program, the facsimile application 42 as a facsimile application program, the scanner application 43 as a scanner application program, the web application 44 as a net file application program, and the marking application 45 as a marking application program. Each of the applications 40 to 45 can be executed by using processes executable on the platform 32, in which a display control program may be mainly executed to control the screen, the key operation, and the job preparation.

Further, a new application can be installed from a network connected by the network management service 57, in which applications can be added or deleted one by one for each of applications.

The web application 44 may include a web server and a web service application interface, in which a HTTP request such as “GET METHOD,” “POST METHOD,” “PUT METHOD,” “DELETE METHOD,” and “HEAD METHOD” may be processed to transmit a HTTP response including HTML. As such, generally required processes, required to be conducted for any application, can be processed by the platform 32 disposed for each of the image forming apparatuses 1 to 6.

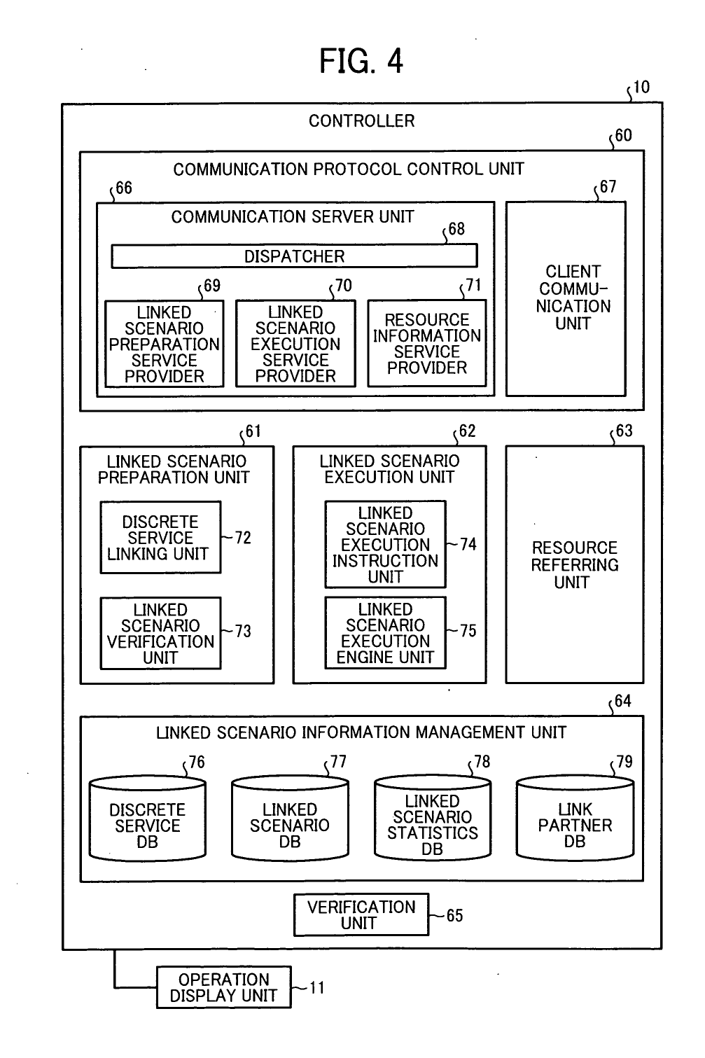

A description is now given of functional configuration of the image forming apparatuses 1 to 6. FIG. 4 shows a functional block diagram of the image forming apparatuses 1 to 6 shown in FIG. 1. Each of the image forming apparatuses 1 to 6 includes the controller 10 that includes various functional units, which can be activated by executing programs stored in the HDD 22, such as a communication protocol control unit 60, a linked scenario preparation unit 61 (or linked scenario generation unit 61), a linked scenario execution unit 62, a resource referring unit 63, a linked scenario information management unit 64, and a verification unit 65. Other known functional units may be disposed in the configuration. Further, FIG. 4 shows the operation display unit 11 (or operation panel 11) used as a user interface for operating the image forming apparatus.

The linked scenario information management unit 64 includes a discrete service database (DB) 76, a linked scenario database DB 77, a linked scenario statistics database (DB) 78, and a link partner database (DB) 79.

The communication protocol control unit 60 controls communications in one image forming apparatus, and communications between one image forming apparatus and other image forming apparatuses (and including other apparatuses disposed on the network 7) used as the link partner apparatuses. The communication protocol control unit 60 may include functional units such as a communication server unit 66, and a client communication unit 67. Other known functional units may be disposed in the configuration.

The communication server unit 66 is used to control the reception of link-request from other image forming apparatuses used as the link partner apparatuses.

The client communication unit 67 is used to control the transmission of link-request to other image forming apparatuses used as the link partner apparatuses.

The communication server unit 66 may include functional units such as a dispatcher 68, a linked scenario preparation service provider 69, a linked scenario execution service provider 70, and a resource information service provider 71. Other known functional units may be disposed in the configuration.

The dispatcher 68 receives a request of preparation of linked scenario, a request of execution of linked scenario, and a request of resource information exchange from the image forming apparatuses used as the link partner apparatuses, wherein some image forming apparatuses may be used directly by a user and other image forming apparatuses may be linked to such image forming apparatuses, and distributes or allocates such requests to each of relevant service providers disposed in the communication server unit 66. Specifically, the dispatcher 68 transmits a request of preparation of linked scenario to the linked scenario preparation service provider 69, transmits a request of execution of linked scenario to the linked scenario execution service provider 70, and transmits a request of exchange of resource information to the resource information service provider 71.

The linked scenario preparation service provider 69 can be used as a reception unit of a preparation instruction of linked scenario preparation service, and operates the linked scenario preparation unit 61 based on a request of preparation of linked scenario requested from one image forming apparatus, which is the apparatus requesting the link of discrete services for preparing a linked scenario with other link partner apparatuses.

The linked scenario execution service provider 70 can also be used as a reception unit of an execution instruction of linked scenario execution service, and operates the linked scenario execution unit 62 based on a request of execution of linked scenario requested from one image forming apparatus, which is the apparatus requesting the link of discrete services for preparing a linked scenario with other link partner apparatuses.

The resource information service provider 71 can be used as a reception unit of instruction of resource information exchange service, and operates the resource referring unit 63 based on a request of exchange of resource information requested from one image forming apparatus, which is the apparatus requesting the link of discrete services for preparing a linked scenario with other link partner apparatuses.

In an example embodiment, for simplicity of explanation only the linked scenario preparation service provider 69, linked scenario execution service provider 70, and resource information service provider 71 are described as the service provider, but a plurality of service providers that can execute discrete services by itself can be disposed.

Example operations of discrete services may be address book operation (user preparation, referencing, updating, and deleting), PDF conversion service, and optical character reading (OCR) service, or the like, but not limited thereto.

The linked scenario preparation unit 61 may include functional units such as a discrete service linking unit 72 and a linked scenario verification unit 73, and can be used as a preparation unit or generation unit of linked scenario.

The linked scenario preparation unit 61 selects a plurality of discrete services from discrete services providable by the link partner apparatuses to prepare a linked scenario by linking the selected discrete services (linked scenario preparation control), to be operated as the linked scenario. The discrete services can be provided by an image forming apparatus used directly by a user of the verification system and other image forming apparatuses disposed on the network 7 as the link partner apparatuses. Other known functional units may be disposed in the configuration.

The discrete service linking unit 72 can be used as a path preparation unit. When the inputting-format and the outputting-format of the linked scenario is designated, the discrete service linking unit 72 can prepare a plurality of path patterns by linking a plurality of discrete services that can satisfy the designated inputting-format and the outputting-format based on the link information, to be described later. As such, the discrete service linking unit 72 can prepare paths by linking each of discrete services for a given linked scenarios.

The linked scenario verification unit 73 verifies the contents included in the plurality of path patterns prepared by the discrete service linking unit 72. In the verification process, the linked scenario verification unit 73 verifies whether overlapping discrete services are included in different paths, wherein the paths are prepared by the discrete service linking unit 72.

As such, the linked scenario verification unit 73 functions as a verification unit to verify whether a combination of specific discrete services substantially overlaps among the prepared paths with each other. In the overlapping determination process, even if some discrete services are the same type, if the formats of the data to be processed are different, such discrete services are identified as not overlapping, whereas if the data format is the same type, such discrete services are identified as overlapping.

In addition, the linked scenario verification unit 73 verifies whether a user has access authorization to the image forming apparatus used as the link partner apparatus providing each of discrete services for the paths prepared by the discrete service linking unit 72.

Further, the linked scenario verification unit 73 verifies whether the image forming apparatus used as the link partner apparatus is in a linkable state. Specifically, if one image forming apparatus used as the link partner apparatus is in a normal operation state, it is determined that the image forming apparatus is linkable, and if the image forming apparatus used as the link partner apparatus is in a non-operation state due to power off, error, or the like, it is determined that the image forming apparatus is in a link-prohibited state.

Further, based on a search result of the priority order information in the linked scenario statistics DB 78, searched by the linked scenario information management unit 64, the linked scenario verification unit 73 selects image forming apparatuses, used as the link partner apparatuses, based on the evaluation of priority items such as distance, processing speed, reliability, and cost of image forming apparatuses to determine one or more of preferable providers of discrete services. As such, the linked scenario verification unit 73 can be used as a selection unit to select image forming apparatuses, which provides each of discrete services for the to-be-prepared paths, based on the priority order information.

Further, the linked scenario verification unit 73 can be also used as an alternative path registration unit to register a linked scenario as an alternative path by selecting one path from the path list displayed on a screen of the operation display unit 11, in which the alternative path is selected from the path list while excluding the path selected by a user as primary path. The alternative path is set just in case the primary path, which is a user-desired path, cannot be operated due to some reasons such as an execution failure of the primary path. The number of alternative path is not limited to one. Further, the linked scenario verification unit 73 can be used as a check unit to check whether each of the image forming apparatuses that provide each of discrete services for the paths is at the link-allowed state.

The linked scenario preparation unit 61 can prepare a plurality of paths for one linked scenarios using the discrete service linking unit 72 and the verification result by the linked scenario verification unit 73. The linked scenario preparation unit 61 can instruct a display of the path list, in which a plurality of path patterns prepared for the linked scenarios can be displayed on a screen of the operation display unit 11.

Further, the linked scenario preparation unit 61 can register one or more linked scenarios to the linked scenario DB 77 via the linked scenario information management unit 64. Specifically, the linked scenario preparation unit 61 can register a primary linked scenario by selecting one path from the path list displayed on the screen, and can register a secondary-selected linked scenario by selecting one path, excluding the path for the primary linked scenario from the path list displayed on the screen, in which the secondary-selected linked scenario can be set as an alternative path for the primary linked scenario.

As such, the linked scenario preparation unit 61 can be used as a path list displaying unit to display the path list composed of a plurality of path patterns prepared by the path preparation unit, and as a linked scenario registration unit to prepare and register one or more of the linked scenarios selected from the path list.

The linked scenario execution unit 62 may include functional units such as a linked scenario execution instruction unit 74 and a linked scenario execution engine unit 75, which controls the execution of linked scenario. The linked scenario execution instruction unit 74 instructs the linked scenario execution engine unit 75 to execute each of discrete services one by one in line with the path set for the linked scenario.

The linked scenario execution engine unit 75 executes each of discrete services one by one based on the instruction from the linked scenario execution instruction unit 74.

The resource referring unit 63 transmits resource information of one image forming apparatus used directly by a user to other image forming apparatuses used as the link partner apparatuses when the other image forming apparatuses requests the resource information included in one image forming apparatus. Further, the resource referring unit 63 requests other image forming apparatuses used as the link partner apparatuses to transmit resource information in other image forming apparatuses to one image forming apparatus requesting such resource information, in which the resource referring unit 63 receives the resource information of other image forming apparatus. As such, the resource referring unit 63 can be used as an information exchange unit to exchange information among the image forming apparatuses. Such information exchange may be conducted periodically such as every hour, every day, every week, or the like. The exchanged information may include discrete services, service performance level, and usage charge set for each of discrete services providable by each of the image forming apparatuses.

In response to the request from the linked scenario preparation unit 61 and/or the linked scenario execution unit 62, the linked scenario information management unit 64 searches data in the discrete service DB 76, linked scenario database DB 77, linked scenario statistics DB 78, and link partner DB 79. Then, the linked scenario information management unit 64 returns a search result to the linked scenario preparation unit 61 and/or the linked scenario execution unit 62. Further, the linked scenario information management unit 64 conducts the management of each DBs such as updating data in the discrete service DB 76, linked scenario DB 77, linked scenario statistics DB 78, and the link partner DB 79.

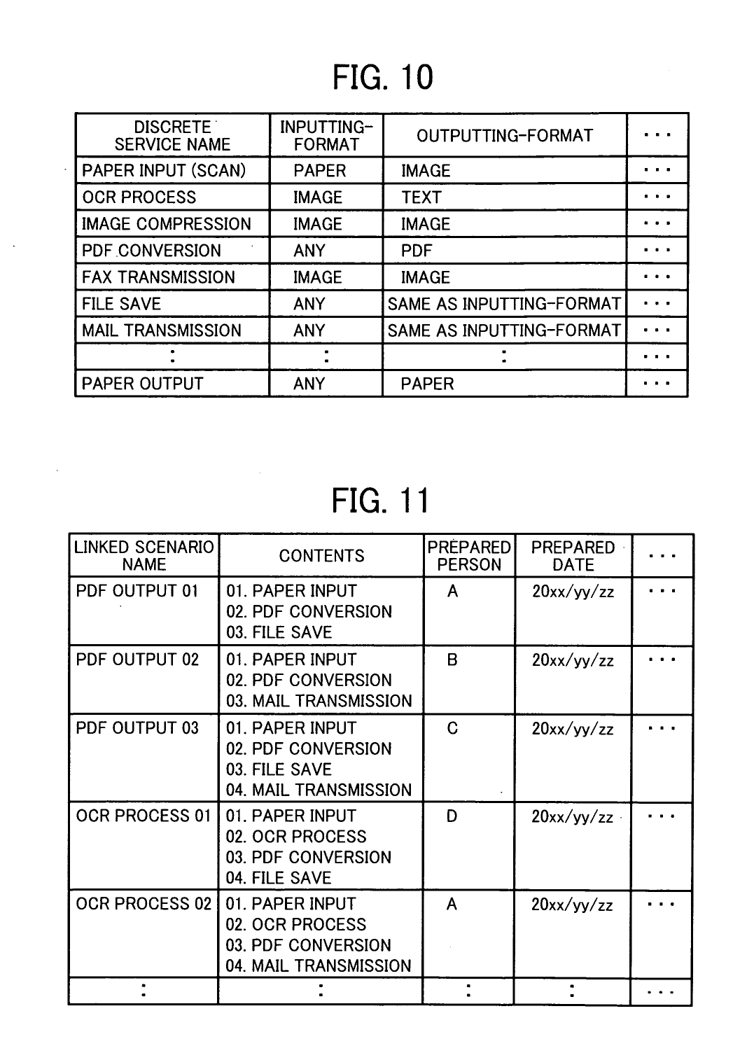

The discrete service DB 76 is a storage to store information of discrete services such as names of discrete services, inputting-formats, and outputting-formats, or the like (see FIG. 10).

The linked scenario DB 77 is a storage to store information of linked scenario such as names of linked scenarios, contents of linked scenarios arranged in a flow sequence, prepared person, prepared date, or the like (see FIG. 11).

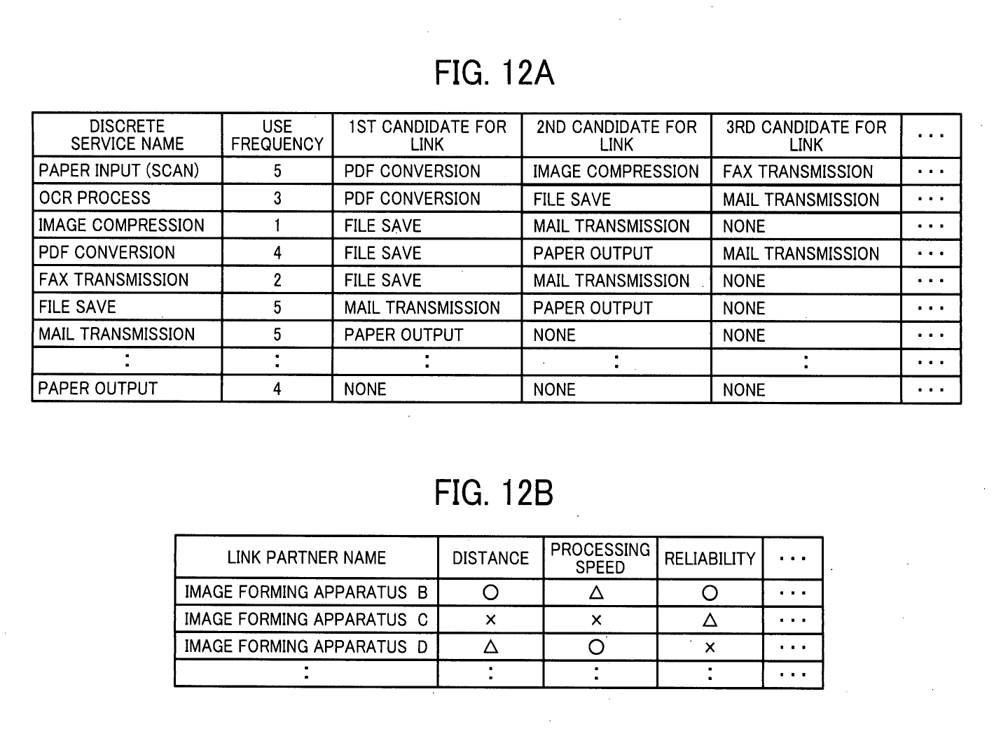

The linked scenario statistics DB 78 is a storage device to store link information and priority order information (see FIGS. 12A and 12B). The linked scenario statistics DB 78 stores link information, which arranges discrete services providable by each of the image forming apparatuses in the order of linking frequency (or linking closeness), in which discrete services are successively arranged as link candidates from high to low linking frequency (or linking closeness). Specifically, one discrete service is linked to another discrete service with a high frequency, and linked to still another discrete service with a low frequency. As such, the link information indicates the linking strength among the discrete services.

The linked scenario statistics DB 78 determines and stores the priority order information of each of the image forming apparatuses based on information including the service performance level, usage charge set for each of discrete services providable by each of the image forming apparatuses, and operation history information of each of discrete services executed in the past by each of the image forming apparatuses.

As such, the linked scenario statistics DB 78 stores the link information of discrete services by showing as the link candidates arranged from high to low linking frequency (or linking closeness), and the priority order information of the image forming apparatuses (used as the link partner apparatuses) using the distance, processing speed, and reliability set for each of the image forming apparatuses used as the link partner apparatuses. The information of distance, processing speed, and reliability may be used as priority items to determine priority level among the image forming apparatuses. The link information and priority order information may be statistical information obtained from experiments conducted in the past, history information of linked scenario prepared in the past, and/or history information of linked scenario executed in the past.

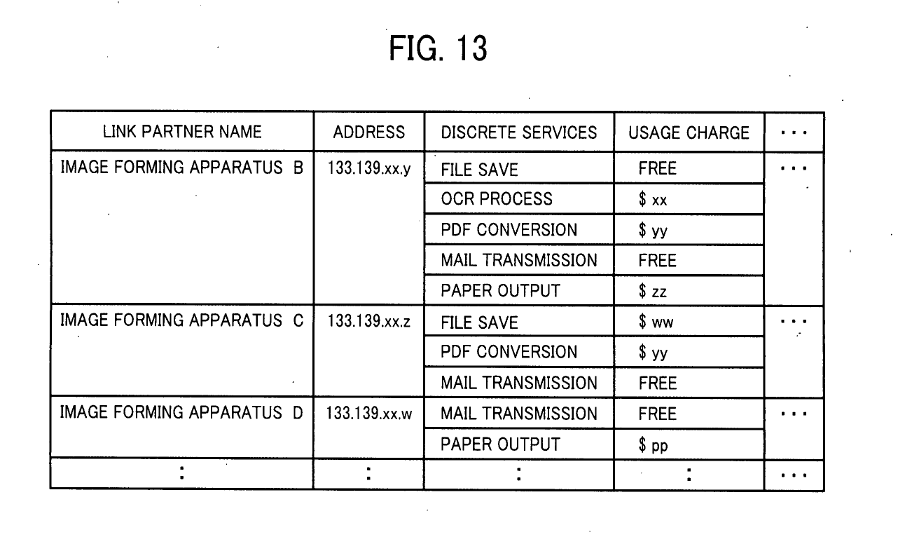

The link partner DB 79 stores information of link partner apparatuses connectable each other via the network 7. For example, the link partner DB 79 stores names, addresses, discrete services possessed or included in the link partner apparatuses, and usage charges of discrete services of the link partner apparatuses (see FIG. 13). The verification unit 65 checks whether a user has access authorization for the concerned image forming apparatus.

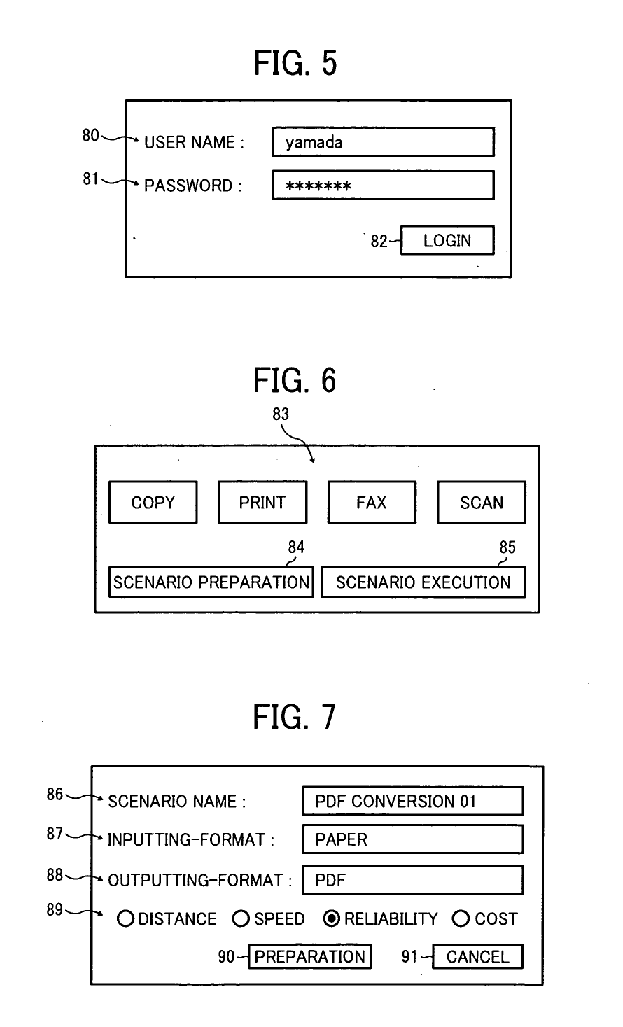

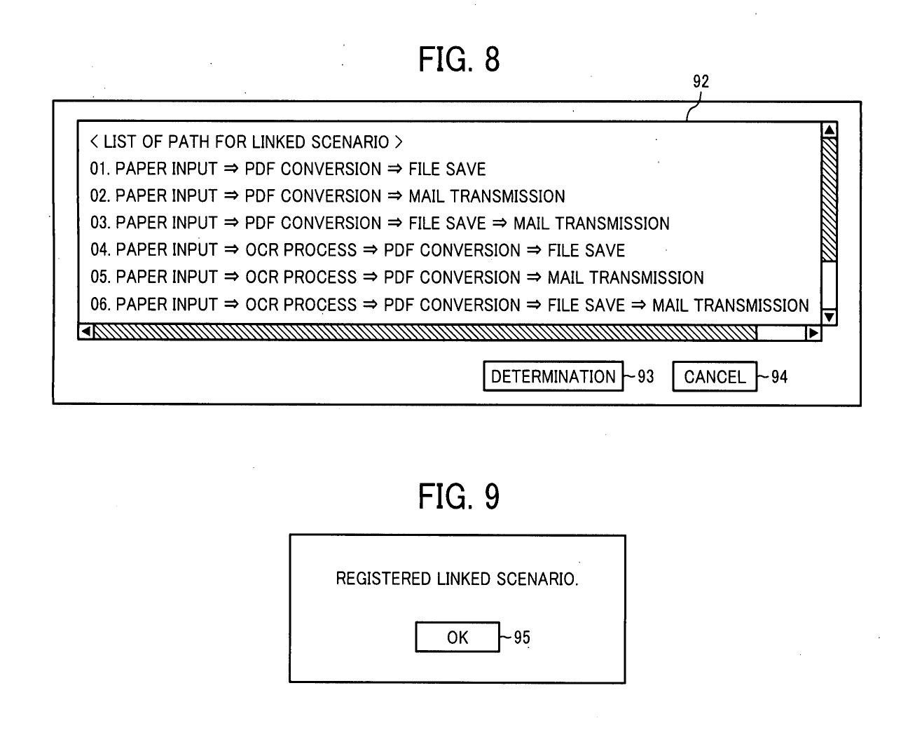

A description is given of examples of user interfaces of the image forming apparatuses 1 to 6 with reference to FIGS. 5 to 9. FIG. 5 shows one example of a log-in screen displayable on the operation display unit 11 of the image forming apparatuses 1 to 6 of FIG. 4. FIG. 6 shows one example of a menu of application selection displayable on the operation display unit 11 of the image forming apparatuses 1 to 6 of FIG. 4. FIG. 7 shows one example of a linked scenario preparation screen displayable on the operation display unit 11 of the image forming apparatuses 1 to 6 of FIG. 4. FIG. 8 shows one example of a linked scenario list screen displayable on the operation display unit 11 of the image forming apparatuses 1 to 6 of FIG. 4. FIG. 9 shows one example of a message displayable on the operation display unit 11 of the image forming apparatuses 1 to 6 of FIG. 4 when a linked scenario is registered.

The controller 10 of the image forming apparatuses 1 to 6 displays the log-in screen (FIG. 5) on the operation display unit 11, and the controller 10 requests an input of a user name and a password to a user to conduct the user verification. The user inputs a user name and a password, registered in advance, in a user name input section 80 and a password input section 81 displayed on a log-in screen and then presses a log-in button 82 to request the log-in.

When the log-in is requested, the verification unit 65 in the controller 10 of the image forming apparatuses 1 to 6 conducts the user verification processing based on the input user name and password. If the input user name and password are identical to the user name and password registered in advance, the verification unit 65 verifies an access authorization of the user, and then displays an application selection menu shown in FIG. 6. In contrast, if a wrong user name and/or password is input, the verification unit 65 does not verify an access authorization of the user, and requests a re-input of user name and password while displaying the log-in screen.

The application selection menu of FIG. 6 includes, for example, function buttons 83, a linked scenario preparation button 84, and a linked scenario execution button 85. The function buttons 83 includes buttons such as COPY, PRINT, FAX, and SCAN to select the functions of copy, print, facsimile communication (facsimile transmission/reception), and image scanning. The linked scenario preparation button 84 is used to select a linked scenario preparation. The linked scenario execution button 85 is used to instruct the execution of a linked scenario.

When the user presses the linked scenario preparation button 84 (“scenario preparation” button in FIG. 6), the controller 10 shifts the screen image to the linked scenario preparation screen shown in FIG. 7, and the linked scenario preparation unit 61 controls the preparation of linked scenario. When the user presses linked scenario execution button 85 (“scenario execution” button in FIG. 6), the controller 10 shifts the screen image shifts to the scenario execution screen, and the linked scenario execution unit 62 controls the execution of linked scenario.

The linked scenario preparation screen shown in FIG. 7 includes a linked scenario name input section 86, an inputting-format input section 87, an outputting-format input section 88, a priority item section 89, a preparation button 90 to execute preparation of linked scenario, and a cancel button 91.

The linked scenario name input section 86 can be input with a name or title of a to-be-prepared linked scenario. The inputting-format input section 87 and the outputting-format input section 88 can be input with the inputting-format and the outputting-format, respectively, used for preparing a linked scenario to be conducted by the link partner apparatuses. The priority item section 89 is used to select priority items to be used for preparing a linked scenario to be conducted by the link partner apparatuses. The priority items may be distance, processing speed, reliability, and cost such as usage charge set to the link partner apparatuses. The priority items can be selected for one or more items.

Upon inputting such information, the preparation button 90 (“preparation” button in FIG. 7) can be pressed to execute the preparation of linked scenario. The cancel button 91 can be used to cancel the above input information.

When the priority item of “distance” is selected at the priority item section 89, the linked scenario preparation unit 61 prepares a linked scenario using a discrete service providable by one image forming apparatus having the highest network communication speed (e.g., transmission speed) as a high priority apparatus among the image forming apparatus used as the link partner apparatuses.

Further, when the priority item of “processing speed” is selected, a linked scenario is prepared using discrete services providable by one image forming apparatus having a high speed performance on processing among the image forming apparatus used as the link partner apparatuses.

Further, when the priority item of “reliability” is selected, a linked scenario is prepared using discrete services providable by one image forming apparatus having the highest reliability for executing discrete services among the image forming apparatus used as the link partner apparatuses. The high/low level of reliability can be determined based on the operation history information of discrete services used in the past linked scenarios. For example, when the discrete services are used, the number of execution times and the number of successful execution times are counted, and the number of successful execution times is divided by the number of total execution times to obtain the ratio of successful execution. Based on the ratio of successful execution, the reliability can be set from high to low level.

Further, when the priority item of “cost such as usage charge” is selected, a linked scenario is prepared using discrete services providable by one image forming apparatus having the least expensive usage charge among the image forming apparatus used as the link partner apparatus, wherein such cost information can be obtained by exchanging the resource information among the link partner apparatuses.

As shown in FIG. 7, the user inputs a name or title of linked scenario (e.g., “PDF conversion 01”) to be prepared by using the link partner apparatuses to the linked scenario name input section 86, and also inputs the inputting-format of “paper” and the outputting-format of “PDF” to the inputting-format input section 87 and the outputting-format input section 88, respectively as the user input information, input to the image forming apparatuses by a user, in which when the user inputs the title of linked scenario, the inputting-format (e.g., paper), and the outputting-format (e.g., PDF), a linked scenario can be prepared automatically by using the image forming apparatuses according to the example embodiment. Then, the user selects and inputs the priority item of “reliability” at the priority item section 89, and presses the preparation execution button 90 to request a preparation of linked scenario. Upon pressing the preparation execution button 90, the linked scenario preparation unit 61 prepares one or more path patterns for one linked scenario based on the inputting-format, outputting format, and the selected priority item. After verifying each of prepared paths, a list of path for the linked scenario shown in FIG. 8 can be displayed.

The linked scenario list screen shown in FIG. 8 includes, for example, a list display area 92, a determination button 93, and a cancel button 94. Based on the information input from the linked scenario preparation screen such as the inputting-format, outputting-format, and priority item, the list display area 92 displays a list of path for the linked scenario, automatically prepared by the link partner apparatuses.

The determination button 93 can be pressed to enter the registration of one path set for the linked scenario, selected from the path patterns of the linked scenarios, displayed on the list display area 92. The cancel button 94 can be pressed to cancel the registration of linked scenario. The list display area 92 displays a list of plurality of path patterns prepared for the linked scenario automatically.

The user can select one path, which is desired for the registration, from the list of path prepared for the linked scenario. When the determination button 93 is pressed, the registration of the desired path for the linked scenario can be requested, and the linked scenario preparation unit 61 registers the selected linked scenario, and displays the message (FIG. 9) on the operation display unit 11.

Further, when the cancel button 94 is pressed, the linked scenario preparation unit 61 cancels the registration of linked scenario, and then the screen returns to the display, for example, shown in FIG. 7. Because the registration of linked scenario can be cancelled while the linked scenario is being prepared, a registration of linked scenario that the user does not desire to conduct can be prevented or avoided.

The screen shown in FIG. 9 is one example of a message reporting the completion of registration of the selected linked scenario to the user, and the linked scenario preparation unit 61 displays such message on the operation display unit 11. By pressing an OK button 95 displayed with the message, the user can confirm the registration of linked scenario. Upon pressing the OK button 95, the controller 10 can display the application selection menu (FIG. 6) on the operation display unit 11. The screen displays shown in FIGS. 5 to 9 are screen images of the operation display unit 11 of each of the image forming apparatuses 1 to 6. Such screen displays can be similarly displayed on other information processing apparatus such as PC using a browser or the like.

A description is now given of data types and formats stored in the discrete service DB 76 of FIG. 4. FIG. 10 shows one example of data types and formats stored in the discrete service DB 76 of FIG. 4. The discrete service DB 76 stores information of discrete services by setting a combination of the inputting-format and the outputting-format. For example, the discrete service of “paper input” is stored with the inputting-format of “paper” and the outputting-format of “image.”

The inputting-format of discrete service may include various formats such as sheet (e.g., paper), image, text, data prepared using programs (e.g., WORD, EXCEL, POWERPOINT, PDF (registered trademarks)). When the discrete service can handle any kinds of inputting-format, “any” meaning “any format” is stored as shown in FIG. 10. The outputting-format of discrete services may include various formats as similar to the inputting-format. Further, other information for discrete services can be included in a table shown in FIG. 10. For example, the information of installment date of discrete services can be included in the table shown in FIG. 10.

A description is now given of data types and formats stored in the linked scenario DB 77 of FIG. 4. FIG. 11 shows one example of data types and formats stored in the linked scenario DB 77 of FIG. 4.

The linked scenario DB 77 stores linked scenarios, which are instructed to be registered using the above described linked scenario list screen. Further, the linked scenario DB 77 can store linked scenarios prepared in advance, linked scenarios obtained via the network 7, and linked scenarios stored in a storage medium, or the like. For example, as for the linked scenario having the linked scenario name of “PDF output 01,” discrete services composing the linked scenario are stored in the order of “01.paper input,” “02.PDF conversion,” and “file save,” and information of corresponding prepared person name “A” and prepared date “20xx/yy/zz” of the linked scenario can also be stored. Further, address information of image forming apparatus used as the link partner apparatus, which provides each of the discrete services, can be also stored.

The information shown in FIG. 11 is just one example, and the contents of linked scenarios can be described more in detail as required.

The linked scenario referred as the linked scenario name of “PDF output 01” can be operated by linking discrete services provided by the image forming apparatuses 1 to 6 disposed on the network 7. For example, the paper input can be conducted by using a scanner of the image forming apparatus 1, in which document image is scanned and input. Then, the input image can be converted to PDF format data (PDF conversion) by using the image forming apparatus used directly by a user of the verification system (i.e., image forming apparatus 1) or other image forming apparatus disposed on the network 7. Then, the PDF-converted data can be stored as a data file in the image forming apparatus used directly by the user of the verification system (i.e., image forming apparatus 1) or other image forming apparatus disposed on the network 7.

A description is now given of data types and formats stored in the linked scenario statistics DB 78 of FIG. 4. FIG. 12 shows one example of data types and formats stored in the linked scenario statistics DB 78 of FIG. 4. The linked scenario statistics DB 78 stores link information of discrete services as shown in FIG. 12A, and the priority order information of priority items of each of the image forming apparatuses 1 to 6 disposed on the network 7 as shown in FIG. 12B.

As shown in FIG. 12A, the link information stores the names of discrete services, and the use frequency of each discrete service, which may be determined from the actual used-times of discrete service, and stores discrete services to be successively linked to one given discrete service as link candidates in the order of high to low linking frequency (or linking closeness).

Therefore, based on the number of actual linking times of discrete service used in the past operation, or the statistical data of linking times of discrete services obtained in advance, the link information stores discrete services as the link candidates in the order of high to low linking frequency (or linking closeness) for each of discrete services, in which one discrete service is followed by a next linking candidate for link in the order of high to low linking frequency (or linking closeness).

The link information can be stored as follows. For example, at the top of the list of table, one discrete service of “paper input” is set. The discrete service of “paper input” has the use frequency of “5,” which is the actual number of times that the discrete service of paper input has been used, and a discrete service of “PDF conversion” can be stored in the table as the first candidate for link that can to be linked after the discrete service of “paper input” with highest linking frequency (or linking closeness). Then, a discrete service of “image compression” can be stored in the table as the second candidate for link that can be linked after the discrete service of “paper input,” and a discrete service of “FAX transmission” can be stored in the table as the third candidate for link that can be linked after the discrete service of “paper input.” The first candidate has the highest linking closeness trend, and the linking closeness trend becomes smaller in the order of second, third, fourth candidates, and so on. As such, the linking closeness trend can be used to prepare the link information.

The linking closeness trend can be determined based on the linked scenarios prepared in the past. Specifically, the linking frequency (or linking closeness) of discrete services in the past-prepared linked scenarios can be counted, and the sequential linking order of the discrete services used as linking candidates can be set with the linking closeness trend determined based on the counted values. Therefore, each time a linked scenario is prepared, the use frequency and the linking order of linking candidates shown in FIG. 12A can be changed. Further, a new discrete service may be registered when the exchange of resource information is conducted.

As shown in FIG. 12B, the priority order information for each of the image forming apparatuses 1 to 6 can be stored based on information obtained by exchanging the resource information among the image forming apparatuses 1 to 6, and operation history information, which is the history information of the executed linked scenarios. Each of the priority items such as distance, processing speed, and reliability for each of the image forming apparatuses may be evaluated with a plurality of levels such as three-levels, in which the highest level evaluation is represented by circle (◯), the middle level evaluation is represented by triangle (□), and the lowest level evaluation is represented by cross (×).

Therefore, the linked scenario statistics DB 78 stores the names of the image forming apparatus, used as the link partner apparatuses, and the priority items to be set when preparing a linked scenario by using the ink partner apparatuses. The priority order information of priority items such as distance, processing speed, and reliability among the image forming apparatuses can be corresponded to each of the image forming apparatuses.

For example, when the image forming apparatus 1 used as the link partner apparatus has a name of “image forming apparatus A,” the image forming apparatus 2 used as the link partner apparatus has a name of “image forming apparatus B,” the image forming apparatus 3 used as the link partner apparatus has a name of “image forming apparatus C,” and the image forming apparatus 4 used as the link partner apparatus has a name of “image forming apparatus D,” the image forming apparatus having the highest evaluation for the priority items of distance and reliability is the image forming apparatus B (i.e., image forming apparatus 2), and the image forming apparatus having the highest evaluation for the priority item of processing speed is the image forming apparatus D (i.e., image forming apparatus 4).

Further, although FIG. 12B shows the evaluation result with signs such as ◯, □, ×, the evaluation data can be expressed and stored as numerical values. Further, if the operation history information of past linked scenarios is not available, priority items can be evaluated only for the distance and processing speed, which can be determined by conducting the exchange of resource information among the image forming apparatuses, and the evaluation of reliability may be set at a default value. The default value of reliability may be set for each of the image forming apparatuses.

At each time the resource referring unit 63 implements the resource information exchange, and further, at each time the linked scenario is executed, the priority order information shown in FIG. 12B can be changed. Further, when the resource information exchange is implemented, a name of new link partner apparatus may be registered.

A description is now given of data types and formats stored in the link partner DB 79 of FIG. 4. FIG. 13 shows one example of data types and formats stored in the link partner DB 79 of FIG. 4.

The link partner DB 79 stores names and address of the image forming apparatus used as the link partner apparatuses, a list of discrete services possessed or included in the image forming apparatuses, and usage charge of discrete services, wherein each piece of information can be corresponded with each other as shown in FIG. 13. The address information may be an internet protocol (IP) address, host name, or the like, which enables communication.

Further, the list of discrete services may be resource information included in the image forming apparatus disposed on the network 7, wherein the list of discrete services can be obtained by exchanging the resource information with other image forming apparatuses. Further, the usage charge information means, for example, a usage charge per one time when one discrete service is used.

In an example embodiment, each of the image forming apparatuses 1 to 6 disposed on the network 7 can be assigned with specific names such as image forming apparatuses A to F, which are used as the names of link partner apparatuses.

As for the image forming apparatus 2, the link partner DB 79 stores various types of information such as the name of link partner apparatus as “image forming apparatus B” having the address information of “133.139.xx.y,” and discrete services such as “file save,” “OCR process,” “PDF conversion,” “mail transmission,” and “paper output”, and usage charge information for each of the discrete services (e.g., xx dollars for OCR process) by corresponding each piece of information each other. Further, when the exchange of resource information is implemented, a name, address information, possessed discrete services, and usage charge of a new apparatus, to be used as the link partner apparatus, may be registered.

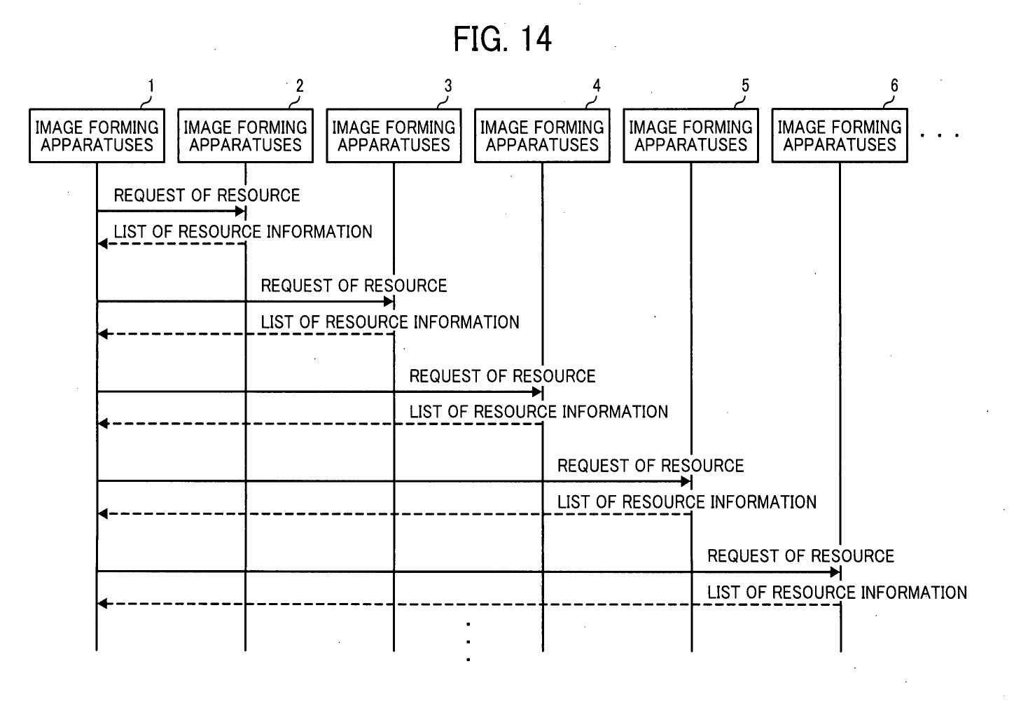

A description is now given of exchange of resource information among the image forming apparatuses 1 to 6 shown in FIG. 4 with reference to FIG. 14. FIG. 14 shows an example sequence chart of resource information exchange when the image forming apparatus 1 (see FIG. 1) initiates the resource information exchange with other image forming apparatuses 2 to 6.

The resource referring unit 63 (FIG. 4) of the image forming apparatus 1 activates the resource information exchange process at a periodic timing, which may be designated by a user in advance, and then the communication protocol control unit 60 of the image forming apparatus 1 transmits a request of resource information exchange to other image forming apparatuses 2 to 6 via the network 7.

When the communication server unit 66 of the communication protocol control unit 60 of each of the image forming apparatuses 2 to 6 receives the request of resource information exchange from the image forming apparatus 1, the dispatcher 68 disposed in each of the image forming apparatuses 2 to 6 transmits the request of resource information exchange to the resource information service provider 71 of the image forming apparatuses 2 to 6. In each of the image forming apparatuses 2 to 6, the resource information service provider 71 activates the resource referring unit 63, and then the resource referring unit 63 prepares a list of resource information of image forming apparatuses 2 to 6, and transmits the list of resource information to the communication server unit 66. The communication server unit 66 uses the client communication unit 67 to transmit the list of resource information of each of the image forming apparatuses 2 to 6 to the image forming apparatus 1.

Further, as similar to the image forming apparatus 1, each of the image forming apparatuses 2 to 6 can request the list of resource information to other image forming apparatuses and obtain the list of resource information from other image forming apparatuses by conducting a similar process. As such, each of the image forming apparatuses 1 to 6 can execute the resource information exchange at a periodic timing, which may be designated by a user, wherein such periodical checking operation may be conducted as a background operation.

Such periodical checking operation can be conducted without the designation by a user, in which a certain condition can be used as a trigger to automatically execute such periodical checking operation. For example, when a certain time condition such as “at midnight (0:00) of every day” is set, such periodical checking operation can be executed at such timing. As such, the periodical checking operation can be conducted by designating a certain condition. The list of resource information may include a list of discrete services possessed or included in each of the image forming apparatuses (including usage charge or service charge of discrete services), hardware specification such as CPU, memory, HDD, communication speed (network band speed), and operation frequency, or the like, but not limited thereto.

When the resource information is exchanged among the link partner apparatuses, the resource referring unit 63 requests the linked scenario information management unit 64 to update the data stored in each DB managed by the linked scenario information management unit 64. If a new image forming apparatus is detected on the network 7 as a new link partner apparatus by conducting the resource information exchange, data of the image forming apparatus to be used as the new link partner apparatus can be added and stored in the link partner DB 79 (FIG. 4).

Further, if a new discrete service is detected on the network 7, the newly detected discrete service can be added and stored in the discrete service DB 76 and the linked scenario statistics DB 78. Further, if the image forming apparatus, being registered as the link partner apparatus, is deleted from the network 7, data of such image forming apparatus can be deleted from each of DBs.

By periodically exchanging the resource information, even when the resource information in the image forming apparatuses (used as the link partner apparatuses) on the network is changed, the resource information available through the network can be automatically updated. Further, if data in the linked scenario statistics DB 78 is updated when preparing and/or executing a linked scenario, the latest statistical information can be used when preparing and/or executing the linked scenario.

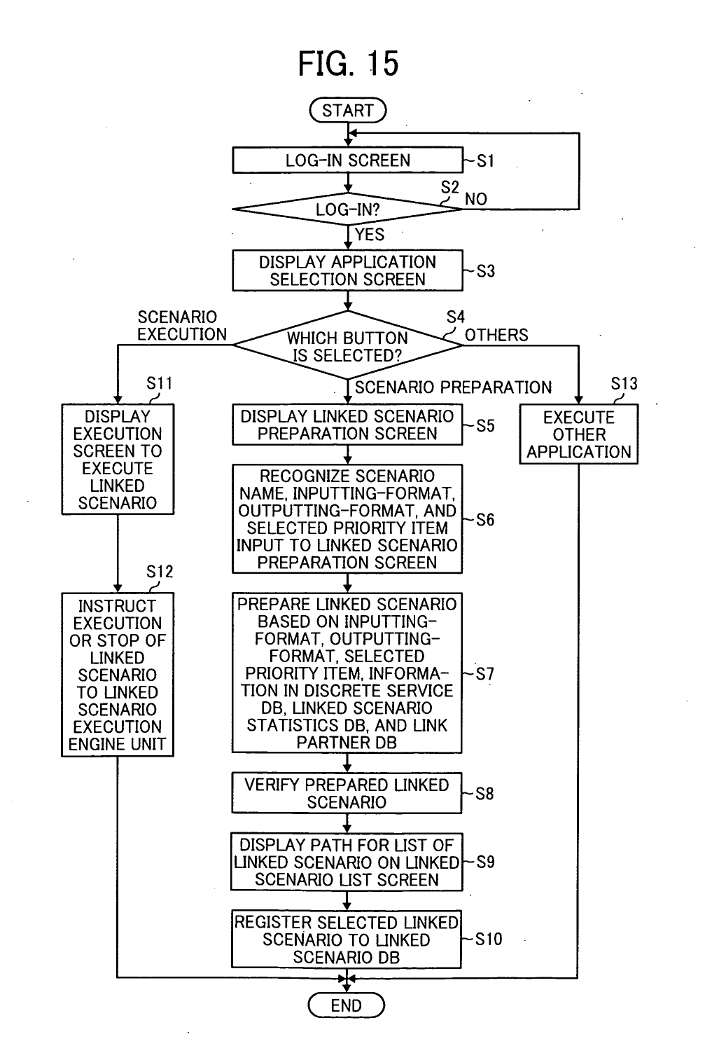

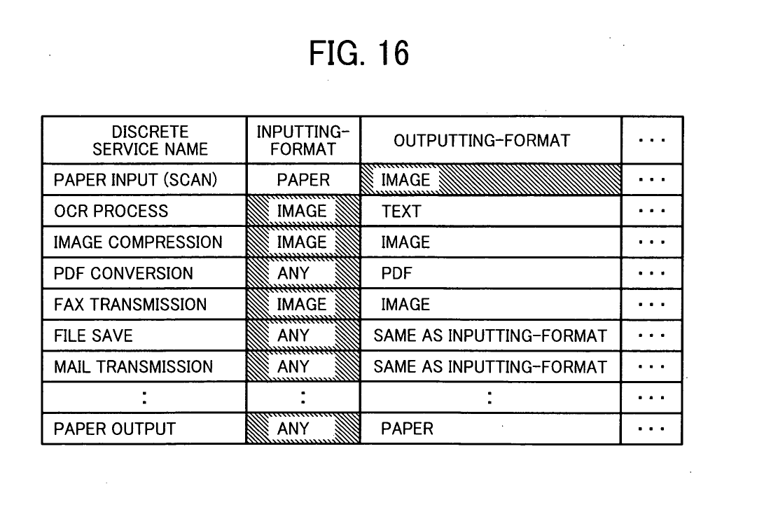

A description is now given to a process when using the image forming apparatuses 1 to 6 show in FIG. 4 with reference to FIG. 15. FIG. 15 shows a flowchart of process when a user uses the image forming apparatus 1 (FIG. 1) when initiating a given job.

The controller 10 displays the log-in screen (FIG. 5) on the operation display unit 11 at step S1. The user inputs a user name and a password to the log-in screen displayed on the operation display unit 11 of the image forming apparatus 1, and presses the log-in button 82 to execute the log-in.

At step S2, the controller 10 determines whether the user name and password input to the log-in screen are an authentic user name and an authentic password for the image forming apparatus (i.e., determines whether the user is an authentic user of apparatus), which means the controller 10 verifies whether the user is the authentic user of the image forming apparatus. If the log-in fails, the process goes back to step S1, and the re-input of user name and password is requested. In contrast, if the log-in succeeds, the process goes to step S3.

At step S3, the log-in screen is shifted to the screen displaying the application selection menu (FIG. 6), in which the controller 10 displays the application selection menu on the operation display unit 11, and the process goes to step S4. At step S4, the user can select applications and functions that the user wants to use from the application selection menu.

If the user wants to use one of the functions of copying, printing, facsimile communication, and image scanning, the user presses the related button in the function buttons 83 on the application selection menu (FIG. 6). If the user wants to use the linked scenario preparation function, the user presses the linked scenario preparation button 84, and if the user wants to use the linked scenario execution function, the user presses the linked scenario execution button 85. At step S4, the controller 10 determines which button is selected by the user, wherein the selected button is any one of the linked scenario preparation button 84, the linked scenario execution button 85, and other buttons.

If the controller 10 determines that the linked scenario preparation button 84 is input, the linked scenario preparation unit 61 is operated, and the process goes to step S5. If the controller 10 determines that the linked scenario execution button 85 is input, the linked scenario execution unit 62 is operated, and the process goes to step S11. If the controller 10 determines that the one of the function buttons 83 is input, the process goes to step S13.

At step S5, the linked scenario preparation unit 61 of the controller 10 displays the linked scenario preparation screen (FIG. 7), and the process goes to step S6. The user inputs a scenario name, an inputting-format, and an outputting-format on the linked scenario preparation screen, selects one or more priority items at the priority item section 89, and presses the preparation execution button 90.

At step S6, when the controller 10 recognizes the pressing of the preparation execution button 90, the controller 10 recognizes the scenario name, the inputting-format, the outputting-format, and the selected priority item input to the linked scenario preparation screen, and the process goes to step S7.

At step S7, the linked scenario preparation unit 61 prepares a linked scenario based on the inputting-format, the outputting-format, the selected priority item, information stored in the discrete service DB 76, the linked scenario statistics DB 78, and the link partner DB 79, and the process goes to step S8. At step S8, the linked scenario preparation unit 61 verifies the prepared linked scenario, and the process goes to step S9.

At step S9, the linked scenario preparation unit 61 displays a path list prepared for the linked scenario (FIG. 8) on the operation display unit 11, in which the linked scenario preparation unit 61 displays a verified path list for the linked scenario on the screen, and the process goes to step S10. The user can select a desired linked scenario from a plurality of path patterns prepared for the linked scenarios, displayed on the screen of the operation display unit 11, and can press the determination button 93 to register the desired linked scenarios.

At step S10, the linked scenario information management unit 64 of the controller 10 stores or registers the user-selected linked scenario to the linked scenario DB 77, and the process ends. If the user-selected linked scenario is an already registered one, the controller 10 reports to the user that the user-selected linked scenario is already registered (e.g., the operation display unit 11 displays a message). If the user-selected linked scenario is not a registered one, the controller 10 registers the linked scenario and also updates information or data of the linked scenario statistics DB 78. The user-selected linked scenario may be referred to as a primary scenario because the user selects such linked scenario as a preferable one.

Further, it is preferable to register another linked scenario (referred to as a secondary linked scenario) as an alternative path for the primary linked scenario just in case of the execution failure of the primary linked scenario. The alternative path is one path selectable from the plurality of path patterns prepared for the linked scenario. The alternative path can be selected from the plurality of path patterns by excluding the path for the primary linked scenario, and can be registered as the alternative path. If a plurality of path patterns can be set as the alternative paths, an alternative path having high performance on the priority items such as distance and processing speed may be selected.

If there is no difference on the performance level of distance and processing speed among the plurality of path patterns, an alternative path using one or more image forming apparatuses operated less frequently compared to other image forming apparatuses can be selected as the alternative path. Further, if no alternative path can be prepared for the linked scenario, the alternative path is not registered. By registering the secondary linked scenario as the alternative path while preparing the primary linked scenario, even if an error occurs during the execution of the primary linked scenario, the alternative path can be used as a backup path to recover from the error condition of the primary linked scenario.

At step S11, the linked scenario execution unit 62 of the controller 10 displays the linked scenario execution screen on the operation display unit 11 to execute the linked scenario, and the process goes to step S12.

At step S12, the user selects a linked scenario to be executed on the linked scenario execution screen, and instructs the execution. Further, if the user wants to stop, suspend, or interrupt the execution due to some reasons during the linked scenario execution, the cancel can be input using the cancel button 94, and the process ends. If the execution instruction is instructed, the linked scenario execution unit 62 of the controller 10 instructs the execution of linked scenario to the linked scenario execution engine unit 75. If the cancelling of execution of linked scenario is instructed, the linked scenario execution unit 62 of the controller 10 instructs the stop of execution of linked scenario, and the process ends. Further, at step S13, the controller 10 executes other application selected by the user, and then the process ends.

A description is now given of a preparation process of linked scenario, conducted at step S7 (FIG. 15) with reference to FIG. 4, and FIGS. 16 to 22. Hereinafter, the preparation process of linked scenario is explained using one example, in which “PDF conversion 01” is input to the linked scenario name input section 86, “paper” is input to the inputting-format input section 87, “PDF” is input to the outputting-format input section 818, and “reliability” is selected at the priority item section 89 in the linked scenario preparation screen as shown in FIG. 7.

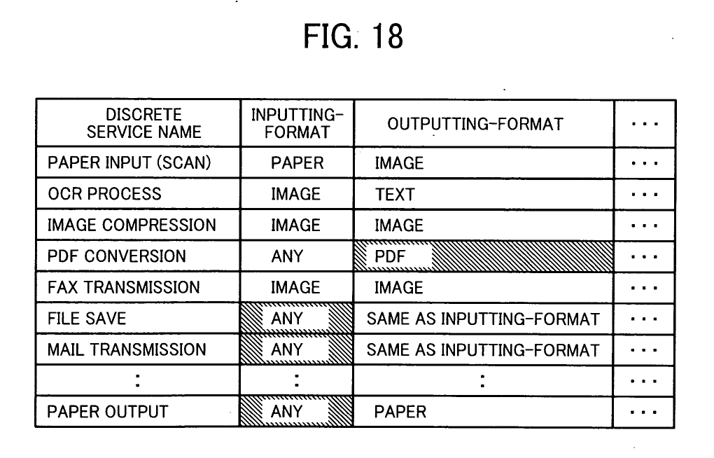

FIGS. 16 and 18 show a plurality of discrete services composing a linked scenario prepared based on the inputting-format “paper” and the outputting-format “PDF,” and a data referring process in the discrete service DB 76 when determining a linking sequence of the discrete services, in which data shown in FIG. 10 is used for explanation.

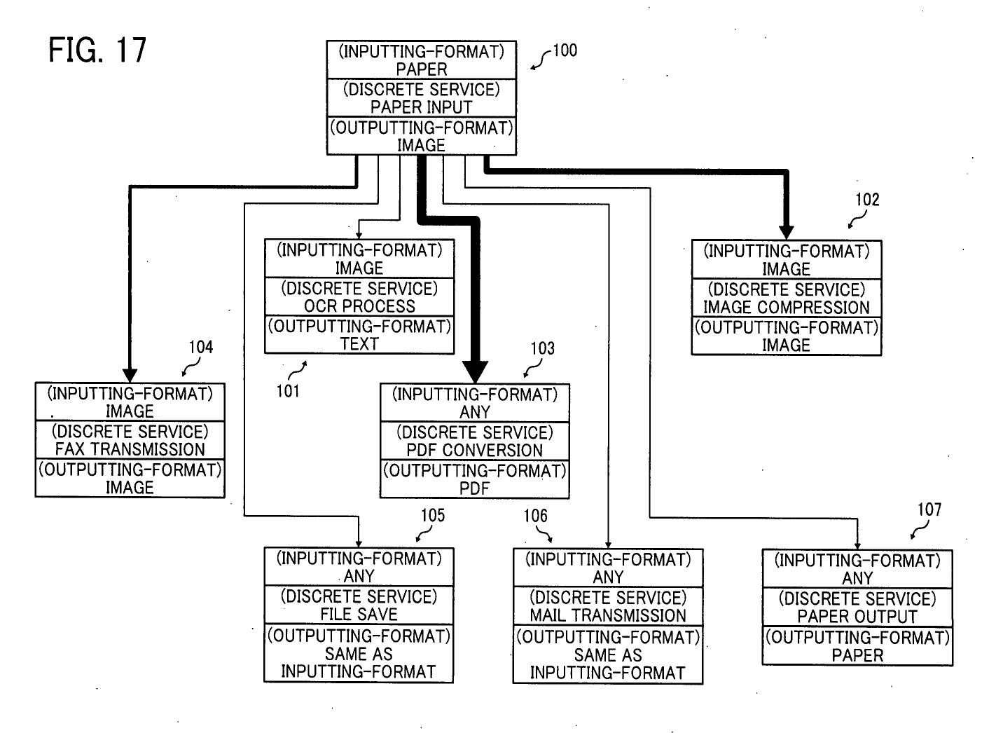

FIGS. 17, 19, and 20 show a plurality of discrete services composing a linked scenario prepared when the inputting-format “paper” and the outputting-format “PDF” are set, and an algorithms to determine a linking sequence of the discrete services.

The process may proceed as follows. The discrete service linking unit 72 in the linked scenario preparation unit 61 (FIG. 4).requests the linked scenario information management unit 64 to search a discrete service corresponding to the inputting-format of “paper.”

The linked scenario information management unit 64 searches data in the discrete service DB 76. When the linked scenario information management unit 64 searches and detects the discrete service of “paper input (scan),” which can correspond to the inputting-format of “paper,” from the data in the discrete service DB 76 as shown in FIG. 16, the linked scenario information management unit 64 transmits the search result to the discrete service linking unit 72.

The discrete service linking unit 72 sets the discrete service of “paper input (scan)” shown by an arrow 100 in FIG. 17 as the first discrete service among a plurality of discrete services composing the linked scenario having the linked scenario name of “PDF conversion 01.” Then, the discrete service linking unit 72 requests a searching of discrete service having the “image” as the inputting-format, wherein the “image” is the outputting-format of the discrete service of “paper input (scan)” as shown in FIG. 16.

The linked scenario information management unit 64 searches data in the discrete service DB 76. The inked scenario information management unit 64 searches discrete services having “image” and “any” as the inputting-format from the data in the discrete service DB 76 (see hatched area in FIG. 16) and checks the inputting-format of “OCR process,” “image compression,” “PDF conversion,” “FAX transmission,” “file save,” “mail transmission”, . . . , and “paper output” shown in FIG. 16. The linked scenario information management unit 64 transmits such checked discrete services to the discrete service linking unit 72.

When the linked scenario information management unit 64 returns such checked discrete services to the discrete service linking unit 72, the discrete service linking unit 72 inquires the linked scenario information management unit 64 to check the link information of each of discrete services of “OCR process,” “image compression,” “PDF conversion,” “FAX transmission,” “file save,” “mail transmission”, . . . , and “paper output” with respect to the discrete service of the “paper input (scan).”

The linked scenario information management unit 64 refers to data shown in FIG. 12A stored in the linked scenario statistics DB 78 to search the link information of each of discrete services of “OCR process,” “image compression,” “PDF conversion,” “FAX transmission,” “file save,” “mail transmission”, . . . , and “paper output” with respect to the discrete service of “paper input (scan),” and returns the search result of link information to the discrete service linking unit 72.

In a case of shown in FIG. 12A, the discrete service of “paper input (scan)” can be linked and followed with the “PDF conversion,” “image compression,” or “FAX transmission” set from the high to low linking closeness trend.

Further, the discrete services of “OCR process,” “file save,” “mail transmission,” . . . , and “paper output” may have a low linking closeness trend compared to the discrete services of “PDF conversion,” “image compression,” and “FAX transmission.” Further, FIG. 17 shows arrows with different thickness, in which discrete services connected by a bold arrow line have a high linking frequency (or linking closeness) between the discrete services.

When the linked scenario information management unit 64 returns the use frequency of each of discrete services to the discrete service linking unit 72, the discrete service linking unit 72 sets the discrete service of “PDF conversion” shown by an arrow 103 in FIG. 17 as the first candidate for link to be linked next to the discrete service of “paper input (scan).” Then, the discrete service linking unit 72 sets the discrete service of “image compression” shown by an arrow 102 in FIG. 17 as the second candidate for link next to the discrete service of “paper input (scan).” Then, the discrete service linking unit 72 sets the discrete service of “FAX transmission” shown by an arrow 104 in FIG. 17 as the third candidate for link next to the discrete service of “paper input (scan).” The first candidate has the highest linking closeness trend, and the linking closeness trend becomes smaller in the order of second, third, fourth candidates, and so on. As such, the linking closeness trend can be used to prepare the link information. FIG. 17 shows arrows with different thickness, in which discrete services connected by a bold arrow line have a high linking frequency (or linking closeness) between the discrete services. To simplify the explanation, the discrete services of “OCR process,” “file save,” “mail transmission,” . . . and “paper output” may be set with a similar linking closeness trend.

In such a configuration, based on the level of linking frequency (or linking closeness), the discrete service linking unit 72 may select the discrete service of “PDF conversion” and the discrete service of “PDF conversion” is linked after the “paper input (scan).”

Then, the discrete service linking unit 72 requests the linked scenario information management unit 64 to search a discrete service having “PDF” as the inputting-format, wherein the “PDF” is the outputting-format of the discrete service of “PDF conversion.”

The linked scenario information management unit 64 refers to data in the discrete service DB 76 to search discrete services of “file save,” “mail transmission,” . . . “paper output” having the inputting-format of “PDF” or “any (including PDF)” from the data in the discrete service DB 76 as shown in FIG. 18 (see hatched area), and returns the searched discrete service to the discrete service linking unit 72.

When the linked scenario information management unit 64 returns a plurality of discrete services to the discrete service linking unit 72, the discrete service linking unit 72 inquires the linked scenario information management unit 64 to search the link information between each of the discrete services of “file save,” “mail transmission,” . . . “paper output” and the discrete service of “PDF conversion.”

The linked scenario information management unit 64 refers to data shown in FIG. 12A in the linked scenario statistics DB 78 to search the link information between each of the discrete services of “file save,” “mail transmission,” . . . “paper output” and the discrete service of “PDF conversion,” and returns the search result of link information to the discrete service linking unit 72.

In a case of data shown in FIG. 12A, the discrete service of “PDF conversion” can be linked and followed with the “file save,” “paper output,” or “mail transmission” set from high to low linking closeness trend. Further, the discrete services of “OCR process,” “PDF conversion,” “image compression,” and “FAX transmission” may have a low linking closeness trend compared to the discrete services of “file save,” “mail transmission”, . . . , and “paper output”.

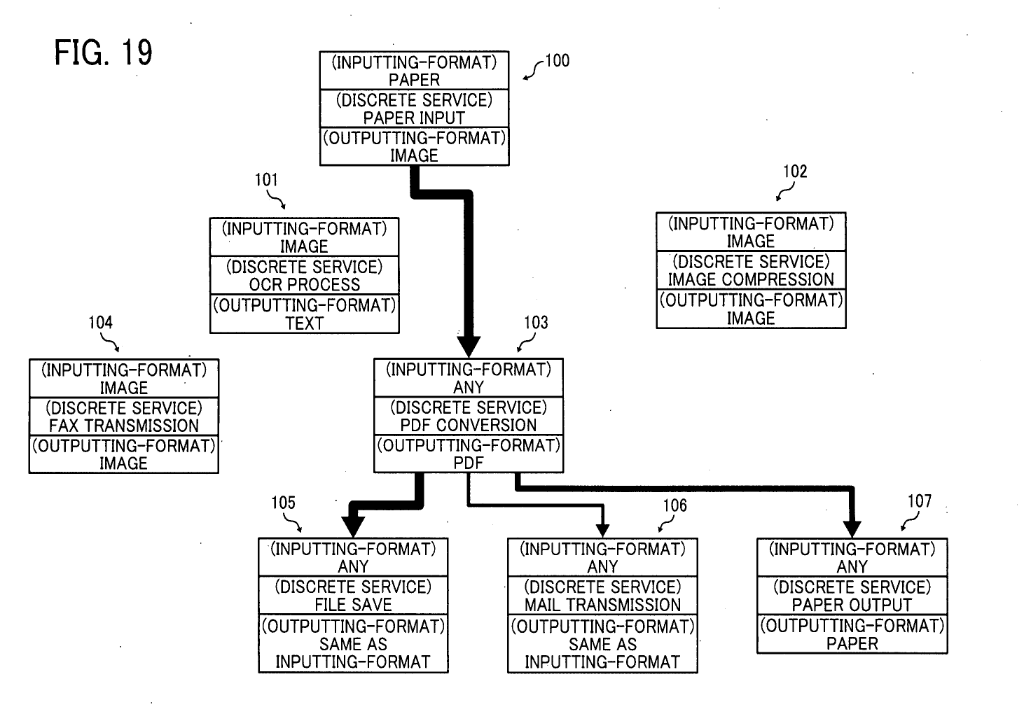

When the linked scenario information management unit 64 returns the use frequency of each of discrete services to the discrete service linking unit 72, the discrete service linking unit 72 sets the discrete service of “file save” shown by an arrow 105 in FIG. 19 as the first candidate for link to be linked next to the discrete service of “PDF conversion.” Then, the discrete service linking unit 72 sets the discrete service of “paper output” shown by an arrow 107 in FIG. 19 as the second candidate for link next to the discrete service of “PDF conversion.” Then, the discrete service linking unit 72 sets the discrete service of “mail transmission” shown by an arrow 106 in FIG. 19 as the third candidate for link next to the discrete service of “PDF conversion.” The first candidate has the highest linking closeness trend, and the linking closeness trend becomes smaller in the order of second, third, fourth candidates, and so on. As such, the linking closeness trend can be used to prepare the link information. FIG. 19 shows arrows with different thickness, in which discrete services connected by a bold arrow line have a high linking frequency (or linking closeness) between the discrete services.

Accordingly, based on the level of linking frequency (or linking closeness), the discrete service linking unit 72 may select the discrete service of “file save” as a discrete service to be linked next to the discrete service of “PDF conversion.”

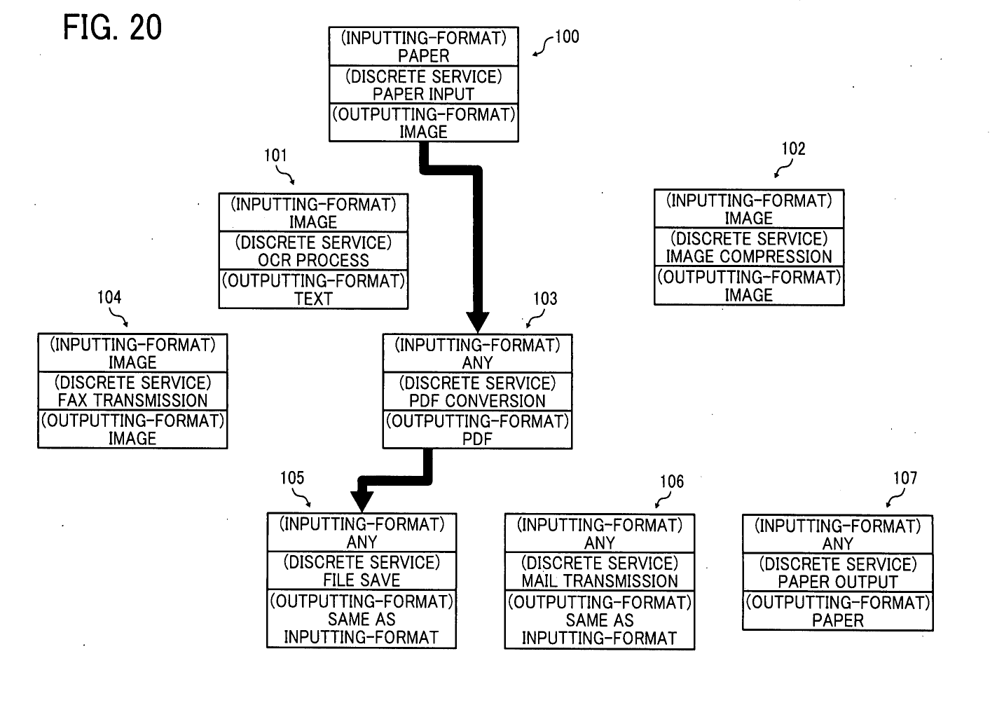

Because the outputting-format of discrete service of “file save” is same as the inputting-format of discrete service of “file save,” the discrete service linking unit 72 completes the linking of discrete services, and prepares a path composed of the discrete service of “paper input (scan)” (see arrow 100), the discrete service of “PDF conversion” (see arrow 103), and the discrete service of “file save” (see arrow 105) as the linked scenario for the linked scenario name of “PDF conversion 01” as shown in FIG. 20. As such, the discrete service linking unit 72 can prepare a path composed of discrete services used for the linked scenario having the inputting-format of “paper” and the outputting-format of “PDF” by linking the discrete services one by one.

As such, the discrete service linking unit 72 refers to discrete services, used in the past, in the linked scenario statistics DB 78, and statistical information of the link partner apparatuses to prepare the paths for of the linked scenario, composed of discrete services, by linking a plurality of discrete services from high to low linking closeness trend. Then, the linked scenario verification unit 73 verifies whether the prepared paths have an overlapping combination of discrete services with each other. Further, the linked scenario verification unit 73 verifies whether a user has a use authorization of the image forming apparatus used as the link partner apparatus, by which only the authorized user can access to the image forming apparatus. Further, the linked scenario verification unit 73 verifies whether the image forming apparatus used as the link partner apparatus is at the link-allowed state. If power OFF or error occurs to the image forming apparatus, such apparatus is at the link-prohibited state. As such, a use authorization with the link partner apparatus and a link-allowed state of the link partner apparatus can be verified for the prepared linked scenario and the user, and the link-prohibited state of the link partner apparatus due to power OFF or error can be detected for the prepared linked scenario before executing the linked scenario, by which the execution failure of the linked scenario due to the failed user authorization or error-occurring at the link partner apparatus can be prevented.

A description is given of overlapping of combinations of discrete services with the following example paths.

“paper input→PDF conversion→mail→FAX”

“paper input→PDF conversion→FAX→mail”

In this case, one path has a combination of “mail→FAX” and another path has a combination of “FAX→mail,” which are substantially identical operations although the sequence is different each other, and thereby the above paths have the overlapping discrete services with each other.

Further, when “paper input→PDF conversion→file save→mail→file save” is conducted in one path, the 20- file save is conducted for two-times in one path, by which the path has the overlapping discrete services. As such, if a plurality of path patterns having substantially same contents are to be prepared for the linked scenario, only one of them may be displayed, by which a user can find a desired linked scenario easily.

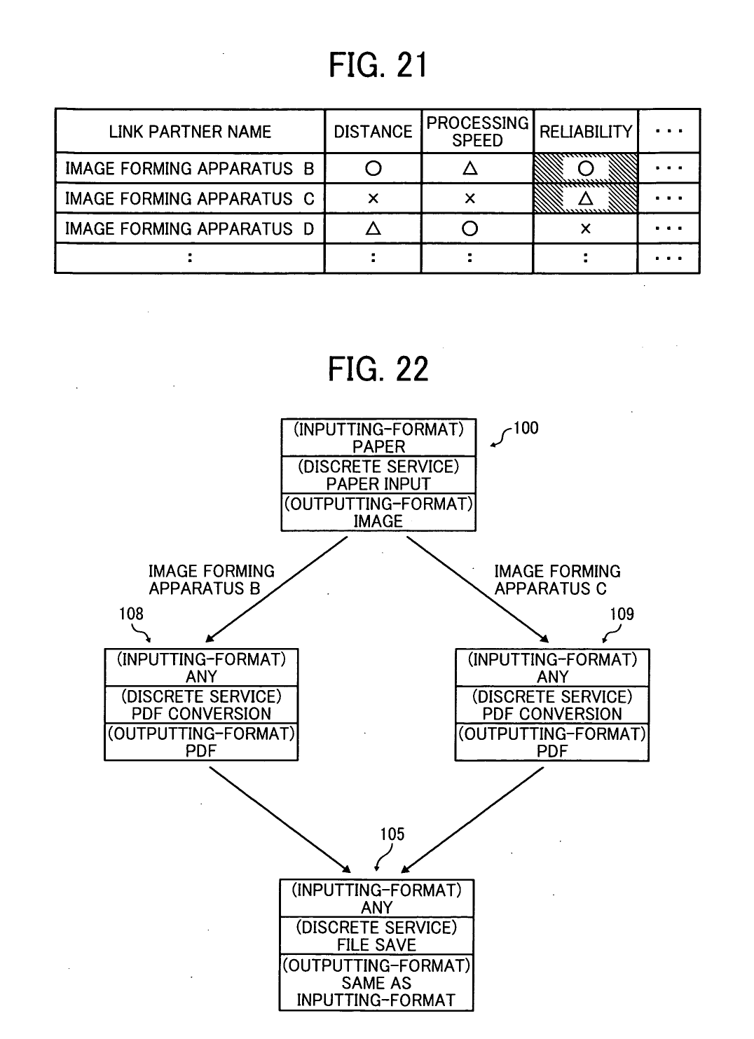

A description is given of a process of selecting image forming apparatuses that provide each of discrete services for preparing paths with reference to FIG. 21 and FIG. 22.

FIG. 21 shows a data referring process of priority order information for each of priority items set for the link partner apparatuses, which can be selected as the image forming apparatus to provide the discrete service of “PDF conversion,” which are stored in the linked scenario statistics DB 78 as shown in FIG. 12B.

FIG. 22 shows an algorithm of selecting an image forming apparatus to provide the discrete service of “PDF conversion” from a plurality of image forming apparatuses.

As shown in FIG. 22, if the discrete service of “paper input” (arrow 100) is to be linked with the discrete service of “PDF conversion,” and the discrete service of “PDF conversion” can be provided by any one of the image forming apparatus B (or image forming apparatus 2)” shown by an arrow 108, and the image forming apparatus C (or image forming apparatus 3) shown by an arrow 109, both having the discrete service of “PDF conversion, the linked scenario verification unit 73 may select the image forming apparatus B as the discrete service linked next to the discrete service of “paper input” (arrow 100) based on the priority order information of “reliability” shown in FIG. 21 (see hatched area), wherein the priority item of “reliability” can be selected at the priority item section 89 on the linked scenario preparation screen (FIG. 7).

In such process, the path using the image forming apparatus C (or image forming apparatus 3) may not be deleted, but can be registered as an alternative path by using the linked scenario verification unit 73 as a precaution when the path using image forming apparatus B (or image forming apparatus 2) cannot be executed due to some reasons.

If the reliability of two paths of the image forming apparatuses B and C are at the same level, a path having higher performance on distance and/or processing speed may be selected. Further, if the distance and processing speed of the image forming apparatuses B and C are at the same level, a path using an image forming apparatus operated less frequently compared to other image forming apparatuses may be selected. The operation frequency of image forming apparatuses can be obtained by exchanging the resource information among the image forming apparatuses.

Further, if the priority item of “usage charge” is selected, a path using discrete services having less expensive usage charge can be selected by selecting an image forming apparatus that can provide such less expensive usage charge, wherein the image forming apparatuses selectable as the link partner apparatus can be searched in the link partner DB 79 (FIG. 13). As such, the linked scenario can be checked using the priority items such as distance, processing speed, reliability, cost, designated by a user, by which a user expected performance can be provided.

As above described, the priority items may include the distance (e.g., select an image forming apparatus having a broad network band), processing.,speed (e.g., select an image forming apparatus having a high speed processing performance), reliability (e.g., select an image forming apparatus having low possibility of error occurrence), cost (e.g., select an image forming apparatus having a low usage charge for discrete service).

Further, the priority item may include other items such as apparatus availability on timeline (e.g., select an image forming apparatus having been used with a lesser time for jobs), operation time duration (e.g., select an image forming apparatus having set to power ON for a long time), quality (e.g., select an image forming apparatus having high image printing quality such as clear printing), power consumption (e.g., select an image forming apparatus having a low power consumption for environmental concerns), or the like.

The list of paths prepared for linked scenario can be displayed on the list display area 92 of the linked scenario list screen (FIG. 8). FIG. 8 shows a plurality of path patterns prepared for the linked scenario under the conditions of using the sheet (e.g., paper) as the inputting-format, PDF as the outputting-format, in which the path having high use frequency and composed of least steps is shown at first, and the paths having the greater number of steps are shown downward in the path list. However, the display order of paths in the path list can be switched discretionally by a user or the like.

When one path is selected from the path list, the linked scenario preparation unit 61 (FIG. 4) requests the linked scenario information management unit 64 to register the information of image forming apparatuses that provide each of discrete services for the selected path as the link partner apparatuses. Then, the linked scenario information management unit 64 searches the name and address information of the link partner apparatuses, which can correspond to each of discrete services of the selected path from the link partner DB 79.

The linked scenario information management unit 64 corresponds the name and address information of the link partner apparatuses that can provide each of discrete services set in the path, and the name of linked scenario (e.g., contents of linked scenario of “PDF conversion 01”), and registers the linked scenario of “PDF conversion 01” with the name and address information of the link partner apparatuses and other information such as prepared person and prepared data to the linked scenario DB 77.

The linked scenario registered in the linked scenario DB 77 can be selected by a user and can be executed by the linked scenario execution unit 62 when the execution of registered linked scenario is requested. As such, the linked scenario composed of a plurality of combinations of discrete services provided by the image forming apparatuses 1 to 6, disposed on the network 7, can be implemented.

In the above described image forming apparatuses according to an example embodiment, when a user determines a to-be-executed process by designating a combination of the inputting-format and the outputting-format of discrete services providable by a plurality of image forming apparatuses disposed on a network, a plurality of path patterns prepared by linking a plurality of discrete services can be automatically prepared while satisfying the designated inputting-format and the outputting-format without setting detail conditions for the linked scenario, by which a user may not feel the inconvenience that is felt on the conventional linked scenario preparation support system, and thereby the user convenience can be enhanced in the present invention.

Further, a program according to the above described example embodiment can be used to prepare a linked scenario for other apparatuses such as portable terminal device or apparatus. Further, the program according to the above described example embodiment can be stored in a portable storage medium, by which the program can be installed to the computer of image forming apparatuses and/or information processing apparatuses disposed at different sites and the linked scenario can be prepared using such image forming apparatuses. Further, the program according to the above described example embodiment can be distributed via network and installed to the computer of image forming apparatuses and/or information processing apparatuses disposed at different sites.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, work station) may control an information processing apparatus or an image processing apparatus such as image forming apparatus using a computer-readable program, which can execute the above-described processes or steps. Further, in the above-described exemplary embodiment, a storage device (or recording medium), which can store computer-readable program, may be a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, hard disk in a server, or the like, but not limited these. Further, a computer-readable program can be downloaded to a particular computer (e.g., personal computer) via a network such as the internet, or a computer-readable program can be installed to a particular computer from the above-mentioned storage device, by which the particular computer may be used for the system or apparatus according to an example embodiment, for example.

The image forming apparatus, the preparation method of linked scenario, the program for the preparation method of linked scenario, and computer-readable storage medium storing the program for the preparation method of linked scenario can be applied to image forming apparatuses such as printers, facsimile machines, copiers, multi-functional apparatuses, which may be known as multi-functional peripherals (MFP), or the like, and further to various types of information processing apparatuses.

In the above described example embodiment, information processing apparatuses or devices distributed on a network as a distributed network system can be used to prepare a linked scenario as a single integrated service by linking discrete services of apparatuses or devices and executing the linked scenario using the above described preparation method of the linked scenario, in which a workload of preparation work of linked scenario can be reduced.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information processing apparatus connectable to other information processing apparatuses useable as link partner apparatuses via a network, in which a linked scenario preparable by selecting and linking a plurality of discrete services providable by the information processing apparatus and the link partner apparatuses, the linked scenario being composed of selected and linked discrete services operable by a given combination of the information processing apparatus and the link partner apparatuses, the information processing apparatus comprising a processor configured to conduct the steps of:
storing link information arranging each of the discrete services providable by the information processing apparatus and the link partner apparatuses as link candidates, successively arranged from high to low linking closeness trend set for the discrete services;
preparing a plurality of path patterns for the linked scenario by linking a plurality of discrete services based on the link information, in which the path patterns are prepared to satisfy an inputting format and an outputting format designated for the linked scenario;
displaying the plurality of path patterns prepared for the linked scenario as a path list; and
registering a primary linked scenario by selecting one path from the path list.

2. The information processing apparatus of claim 1, wherein the processor is further configured to conduct the steps of:
determining and storing priority order information of each of the link partner apparatuses based on information including a) performance level obtained from each of the link partner apparatuses, b) usage charge for each of the discrete services providable by each of the link partner apparatuses, and c) operation history information of discrete services executed in the past at each of the link partner apparatuses; and
selecting one or more link partner apparatuses based on the priority order information of the link partner apparatuses, the link partner apparatuses providing each of the discrete services configuring the paths prepared for the linked scenario.

3. The information processing apparatus of claim 1, wherein the processor is further configured to conduct the step of verifying whether the two or more prepared paths include a combination of discrete services that substantially overlap.

4. The information processing apparatus of claim 2, wherein the processor is further configured to conduct the step of exchanging information periodically with the link partner apparatuses, the information including discrete services and performance level providable by the link partner apparatuses and usage charge for each of the discrete services providable by the link partner apparatuses.

5. The information processing apparatus of claim 4, wherein the processor further configured to conduct the step of updating the link information and the priority order information.

6. The information processing apparatus of claim 1, wherein the registering step further registers a secondary linked scenario by selecting one linked scenario, not selected as the primary linked scenario, from the path list to set an alternative path for the primary linked scenario.

7. The information processing apparatus of claim 2, wherein the processor further configured to conduct the step of checking whether each of the link partner apparatuses that provide each of the discrete services for the prepared paths is in a linkable state.

8. The information processing apparatus of claim 1, wherein the information processing apparatus is an image forming apparatus.

9. A method of preparing a linked scenario using an information processing apparatus connectable to other information processing apparatuses useable as link partner apparatuses via a network, the linked scenario preparable by selecting and linking a plurality of discrete services providable by the information processing apparatus and the link partner apparatuses, the linked scenario being composed of selected and linked discrete services operable by a given combination of the information processing apparatus and the link partner apparatuses, the method comprising the steps of:
storing link information arranging each of the discrete services providable by the information processing apparatus and the link partner apparatuses as link candidates, successively arranged from high to low linking closeness trend set for the discrete services;
preparing a plurality of path patterns for the linked scenario by linking a plurality of discrete services based on the link information, in which the path patterns are prepared to satisfy an inputting format and an outputting format designated for the linked scenario;
displaying the plurality of path patterns prepared for the linked scenario as a path list; and
registering a primary linked scenario by selecting one path from the path list.

10. The method of claim 9, further comprising the steps of:
determining and storing priority order information of each of the link partner apparatuses based on information including a) performance level obtained from each of the link partner apparatuses, b) usage charge for each of the discrete services providable by each of the link partner apparatuses, and c) operation history information of discrete services executed in the past at each of the link partner apparatuses; and
selecting one ore more link partner apparatuses based on the priority order information of the link partner apparatuses, the link partner apparatuses providing each of the discrete services configuring the paths prepared for the linked scenario.

11. A computer-readable medium storing a program comprising instructions that when executed by a computer cause the computer to execute a method of preparing a linked scenario using an information processing apparatus connectable to other information processing apparatuses useable as link partner apparatuses via a network, the linked scenario preparable by selecting and linking a plurality of discrete services providable by the information processing apparatus and the link partner apparatuses, the linked scenario being composed of selected and linked discrete services operable by a given combination of the information processing apparatus and the link partner apparatuses, the method comprising the steps of:
storing link information arranging each of the discrete services providable by the information processing apparatus and the link partner apparatuses as link candidates, successively arranged from high to low linking closeness trend set for the discrete services;
preparing a plurality of path patterns for the linked scenario by linking a plurality of discrete services based on the link information, in which the path patterns are prepared to satisfy an inputting format and an outputting format designated for the linked scenario;
displaying the plurality of path patterns prepared for the linked scenario as a path list; and
registering a primary linked scenario by selecting one path from the path list.

12. The computer-readable medium of claim 11, wherein the method further comprises the steps of:
determining and storing priority order information of each of the link partner apparatuses based on information including a) performance level obtained from each of the link partner apparatuses, b) usage charge for each of the discrete services providable by each of the link partner apparatuses, and c) operation history information of discrete services executed in the past at each of the link partner apparatuses; and
selecting one ore more link partner apparatuses based on the priority order information of the link partner apparatuses, the link partner apparatuses providing the each of the discrete services configuring the paths prepared for the linked scenario.
